(19) United States
(12) Patent Application Publication
(10) Pub. No.: US 2016/0089832 A1
(43) Pub. Date: Mar. 31, 2016

(54) RESIN BONDING DEVICE

(71) Applicants: JNL CORPORATION, Tokyo (JP); CENTURY INNOVATION CORPORATION, Tokyo (JP)

(72) Inventor: Hiroaki KAWASAKI, Chiba (JP)

(21) Appl. No.: 14/964,692

(22) Filed: Dec. 10, 2015

Related U.S. Application Data
(63) Continuation of application No. PCT/JP2014/065298, filed on Jun. 10, 2014.

(30) Foreign Application Priority Data
Jun. 11, 2013 (JP) 2013-123256

(51) Int. Cl. B29C 65/42

(52) U.S. Cl. CPC B29C 65/42

(57) ABSTRACT

The present invention provides a resin bonding device comprising: a resin melting injection device A having: a cylinder 1 having an outlet member 5 with a nozzle part formed at a tip-end injection side, a stopper part 6 provided at a rear side for fixation or moving, and a pellet supply opening 11a at an intermediate position; a melting device 2 having a plurality of melting holes 22 formed communicating from inflow-side large openings 22a to outflow-side small openings 22b in the longitudinal direction of a device main body 21, the melting device 2 having a diameter equal to an inner diameter of the cylinder 1; and a heating unit 4 for heating the melting device 2, in which the melting device 2 is provided to be movable or fixed in the cylinder 1; and an adapter 8 that applies the molten resin q injected from the outlet member, to at least one side surface of a first member and a second member and prevents the molten resin q from escaping to resin-bond the first member and the second member to each other.

### CROSS-REFERENCE TO RELATED APPLICATIONS

This application is a continuation application of International Patent Application No. PCT/JP2014/065298 filed on Jun. 10, 2014, which claims priority to Japanese Patent Application No. 2013-123256 filed on Jun. 11, 2013, the entire contents of which are incorporated by reference in their entirety herein.

### TECHNICAL FIELD

The present invention relates to a resin bonding device having a resin melting injection device for melting a plurality of plastic pellets into resin in a melting device in a heated state and injecting the molten resin and an adapter, the resin bonding device being capable of bonding a first member and a second member to each other speedily and airtightly by the molten resin injected from the resin melting injection device.

### BACKGROUND ART

Generally, there are screw-type and plunger-type injection devices. As representative examples, a screw-type injection device is disclosed in the patent literature 1 and a plunger-type injection device is disclosed in the patent literature 2. As disclosed in these literatures, the injection device is mainly formed of a cylinder and a screw. Pellets are injected from a hopper provided in the cylinder and are conveyed to the injection nozzle side by rotation of the screw inside the cylinder, while they are heated and melted. Then, the molten resin is gathered at the tip end of the nozzle and injected so that the molten resin is conveyed to a die.

Generally, plastic pellets (hereinafter referred simply as “pellets”) are made from plastic (synthetic resin), and the heat conductivity is 0.07 to 0.20 kcal/m·hr·° C. This is one several hundredth to one several thousandth of the heat conductivity of metal. In view of this, the pellets are approximately heat insulating material. Accordingly, even if the pellets are given a sufficient amount of melting heat to be melted, the heat is hard to reach the inside of the pellets (centers of the pellets), and it takes much time to heat the pellets completely.

Therefore, it is difficult to shorten the time from when each pellet is melted sufficiently and to when resin molding is produced. The pellets need to be melted for a relatively long time in the cylinder and the working efficiency is not good. Besides, in the injection device, each solid of the pellets is heated and moved to the injection side by rotation of the screw, and at this time, a part of many pellets is pressed against the inner wall of the cylinder.

In other words, the pellets are pressed by the inner wall of the cylinder. Then, the surface of the solid of each pressed pellet is partially in contact with the inner wall of the cylinder and melting of each pellet is restricted to a part of the pellet solid in contact with the cylinder. The pellets kneaded in the cylinder by the screw are moved away from the inner wall of the cylinder for a short time and therefore, the pellets are not heated sufficiently and pellet solids are not melted as a whole, resulting in mixture of melted parts and non-melted parts of the pellets.

As the pellets are pressed against the inner wall of the cylinder by screw in a repeated manner, the pellets are completely melted, and when melted pellets are conveyed toward the nozzle, the amount of resin pooled in the cylinder is equal to or more than several tens of times of the amount that is needed for one injection so that an unnecessary amount of pellets remains in the cylinder.

Besides, when the molten resin passes through a gap between the screw and the cylinder, the resin suffers mechanical damage. Particularly, such a problem is often caused when melting pellets with glass fibers and the screw may be worn. Further, as each pellet is partially melted at random, it is inevitable that the like pellets may remain everlastingly in the cylinder. Accordingly, the operation may become particularly difficult when changing pellet materials in the cylinder.

As a substitute as such a screw type, there is a plunger-type injection device. Such a plunger type is simple in structure and is likely to be downsized. For the plunger type, it does not have the defect that the screw may be worn. The patent literature 2 discloses the plunger type injection device having the most basic structure, which is configured to have a head-cut conical shaped heating cylinder having a plurality of through holes, an injection plunger, a supply tube and so on. The injection plunger is used to convey a synthetic resin material to the heating cylinder to be injected. However, the injection device of the patent literature 2 also has various problems.

In the patent literature 2, the injection plunger and the head-cut conical shaped heating cylinder are formed to have different diameters at their facing surfaces, and the diameter of the injection plunger is formed slightly one size smaller than the diameter of the heating cylinder at the facing portion. In addition, there is formed an air space surrounded by the tip end of the injection plunger, the heating cylinder, a tip end part of the injection plunger and a supply tube, and this air space is a larger area than the area at the tip end of the injection plunger.

Accordingly, the melted synthetic resin material is once pushed into the air space by the injection plunger, but even when the injection plunger further moves toward the heating cylinder, the synthetic resin material is not able to flow into the through holes of the heating cylinder efficiently and some material may remain in the air space without flowing into the heating cylinder. Then, the residual synthetic resin material in the air space may become an obstacle to a synthetic resin material that is to be newly supplied into the through holes of the heating cylinder. And, there may arise a problem of mixture of the synthetic resin material to be newly supplied and residual resin remaining for a long time to be deteriorated.

Then, the applicant of the present application has developed an injection device in a molding machine which is capable of eliminating the inconveniences of the injection plunger and the head-cut conical shaped heating cylinder and performing the pellet resin melting step and the molten resin injection step extremely efficiently, as disclosed in the patent literature 3. According to this patent literature 3, there has been provided an epoch-making invention that only by pressing a lump of pellets by the plunger, it is possible to cause the pellets to pass through a plurality of cone-shaped holes of the melting device thereby to melt the pellets into molten resin and inject the molten resin simultaneously.

According to this invention, in the melting step of melting pellets, the pellets pass through a plurality of cone-shaped holes of a heated melting device with a predetermined pressure and when the pellets go out of the outlet, the pellet solid becomes molten resin. That is, the melting speed and the injection speed are set to be the same in consideration of the quality of pellet material, viscosity of molten resin, melting temperature, pressure, melting speed, injection speed, flow rate and so on. With this invention, melting is very accelerated in terms of the melting speed. Further, as compared with conventional injection devices, the injection device has been remarkably miniaturized successfully and other application purposes have been proposed.

In the patent literature 3, disclosed is the invention for bonding appropriate members by the injection device. This bonding device uses a conventional injection device and has a major drawback that bonding is difficult to perform smoothly due to a complicated gate part and a small hole diameter. Particularly, there are demands for use of a miniaturized resin melting injection device and successful resin bonding of at least two members with excellent airtightness, without use of rivet, bolt and nut, welding or the like.

### CITATION LIST

### Non-Patent Literature

Patent Literature 1: Japanese Patent Application Publication No. 6(1994)-246802
Patent Literature 2: Japanese Patent Publication No. 36(1961)-9884
Patent Literature 3: Japanese Patent Application Publication No. 10(1998)-44247

### SUMMARY OF INVENTION

### Technical Problem

Then, the problem to be solved by the invention (purpose of the present invention) is to provide a resin bonding device having a miniaturized resin melting injection device and an adapter, capable of successful bonding of first and second members speedily and airtightly with use of resin that is injected from the resin melting injection device.

### Solution to Problem

In order to solve the above-mentioned problem, the present inventor have pursued studies diligently and reached the present invention. That is, a first aspect of the present invention is a resin bonding device comprising: a resin melting injection device having: a cylinder having an outlet member formed at a tip-end injection side in a longitudinal direction, a stopper part provided at a rear side, and a pellet supply opening provided in an intermediate position between the stopper part and the outlet member for supplying plastic pellets; a melting device having a plurality of melting holes formed communicating from inflow-side large openings to outflow-side small openings in the longitudinal direction of a device main body, the melting device having a diameter equal to an inner diameter of the cylinder; a heating unit for heating the melting device; and a drive unit for causing the melting device to move in a reciprocating manner, wherein the outflow-side small openings of the melting device face the outlet member, the melting device operates as a plunger in the cylinder, and a return travel by the drive unit is configured to correspond to a melting step of melting the plastic pellets and an outward travel by the drive unit is configured to correspond to an injection step of molten resin, in the cylinder, an opening and closing valve is provided between the outlet member and the melting device, and the opening and closing valve is configured to open the outflow-side small openings of the melting device in the melting step and to close the outflow-side small openings of the melting device in the injection step; and an adapter for applying the molten resin injected from the outlet member, to at least one side surface of a first member and a second member and preventing the molten resin from escaping to resin-bond the first member and the second member to each other.

A second aspect of the present invention is characterized in that, in the first aspect, the adapter comprises a first adapter and a second adapter, the first adapter has an insertion opening formed therein for inserting a nozzle part for injecting the molten resin generated in the resin melting injection device, and back surfaces of the first adapter and the second adapter are formed to have stopper surfaces for closing connection holes formed respectively in the first member and the second member and for preventing the molten resin from escaping.

A third aspect of the present invention is characterized in that, in the first aspect, the adapter comprises a first adapter and a second adapter, the first adapter has an insertion opening formed therein for inserting a nozzle part for injecting the molten resin generated in the resin melting injection device, and a back surface of the first adapter or the second adapter is formed to have a recess part for closing connection holes formed in the first member and the second member and for forming a bulged part of larger diameter than a diameter of the connection holes.

A fourth aspect of the present invention is characterized in that, in the first aspect, the adapter comprises a first adapter and a second adapter, the first adapter has an insertion opening formed therein for inserting a nozzle part for injecting the molten resin generated in the resin melting injection device, and back surfaces of the first adapter and the second adapter are formed to have recess parts for closing connection holes formed respectively in the first member and the second member and for forming bulged parts of larger diameter than a diameter of the connection holes.

A fifth aspect of the present invention is characterized in that, in the first aspect, the adapter is formed as a first adapter, the first adapter has an insertion opening formed therein for inserting a nozzle part for injecting the molten resin generated in the resin melting injection device and is formed to prevent the molten resin from escaping, a back surface of the first adapter is formed to have a recess part for closing a connection hole formed in the first member and for forming a bulged part of larger diameter than a diameter of the connection hole and the first member and the second member are bonded to each other by the molten resin.

A sixth aspect of the present invention is characterized in that, in the first aspect, the adapter comprises a first adapter and a second adapter, the first adapter has an insertion opening for injection of the molten resin, inner surfaces of the first adapter and the second adapter are formed to have a groove that surrounds the first member and the second member around and the groove is formed to communicate with the insertion opening.

A seventh aspect of the present invention is characterized in that, in the first or second aspect, a gate pin is provided inside the outlet member, and when the molten resin is being injected, the gate pin and a nozzle part are opened, and when injection is finished, the gate pin and the nozzle part are closed.

An eighth aspect of the present invention is characterized in that, in the seventh aspect, the gate pin is always controlled to close the nozzle part by an elastic force, a tip end of the gate pin is formed as a tapered part and a tip end inner shape of the nozzle part is formed as an injection tip end opening corresponding to the tapered part.

A ninth aspect of the present invention is characterized in that, in the first or second aspect, the adapter comprises a first adapter and a second adapter, the resin melting injection device comprises a plurality of resin melting injection devices, the first adapter or the second adapter has an insertion opening formed therein for inserting a nozzle part for injecting the molten resin generated in the resin melting injection device and a back surface of the first adapter or the second adapter is formed to have a resin connector for closing connection holes formed in the first member and the second member and to have a stopper surface for preventing the molten resin from escaping.

A tenth aspect of the present invention is a resin bonding device comprising: a resin melting injection device having: a cylinder having an outlet member formed at a tip-end injection side in a longitudinal direction, a cylindrical plunger with a stopper part provided at a rear side, and a pellet supply opening provided in an intermediate position between the plunger and the outlet member for supplying plastic pellets; a drive unit for causing the plunder to move in an axial direction in a reciprocating manner, a melting device having a plurality of melting holes formed communicating from inflow-side large openings to outflow-side small openings in the longitudinal direction of a device main body; a nozzle that is provided at an injection side of the cylinder; and a heating unit for heating the melting device, wherein the melting device is arranged between the plunger and the outlet member, and the plastic pellets supplied from the pellet supply opening flow into the inflow-side large openings by pressure of the plunger and flow out from the outflow-side small openings as molten resin; and an adapter for applying the molten resin injected from the outlet member, to at least one side surface of a first member and a second member and preventing the molten resin from escaping to resin-bond the first member and the second member to each other.

### Advantageous Effects of Invention

According to the present invention, a resin melting injection device for melting a plurality of plastic pellets into resin in a heated melting device and injecting the melted resin and an adapter are used to bond a first member and a second member to each other with molten resin injected from the resin melting injection device, which brings about a great advantage of enabling speedy, airtight and waterproof bonding.

Particularly, in an experimental example, when many pellets are stacked in the cylinder, pressure is applied and thereby, the pellets filled up in the cylinder do not flow back, but are pressed by each other to pass through a plurality of melting holes communicating from inflow-side large openings to outflow-side small openings. With this process, the pellets are melted to be molten resin effectively.

The pressed multiple pellets are able to be conveyed directly and with almost no wastes, to a plurality of inflow-side large openings of the melting holes of the melting device. Accordingly, multiple pellets between the fixed or movable stopper part and the inflow-side surface part of the melting device are able to be conveyed continuously. The pellets pressed between the stopper @art and the inflow-side surface part of the melting device and inserted via the inflow-side large openings of the melting holes are surrounded by the inner circumferential wall surfaces of the melting holes. Since the melting holes are each formed like a cone-shaped channel or a channel with a narrowed end, the pressing force becomes larger as the pellets move toward the outflow-side small openings, and the pellets are heated and melted to be small.

The melting device itself is heated at the melting temperature of the pellets by the heating unit so that pellets become melted. At this time, the whole circumference of each pellet is surrounded by the inner circumferential wall surface of the melting hole and the pellet is able to be melted in balance and approximately evenly from the outer circumferential part to the center. Besides, in the process where each pellet moves from the inflow-side large opening to the outflow-side small opening, as the device main body has large heat capacity, once the device main body is heated to the high temperature, the melting device heats the pellets and keeps the sufficient melting temperature irrespective of the temperatures of melted pellets.

Then, each pellet is melted approximately evenly from the outer circumference to the center, pressed by following pellets that are continuously inserted via the inflow-side large opening and thereby, is able to move toward the outflow-side small opening of the melting hole. During this movement, the pellet continues to be melted, when the pellet passes through the approximately middle portion of the melting hole in the axial direction (longitudinal direction), the pellet is almost melted, and also with the melting heat of the melting device, surrounding pellets continue to be melted in an accelerated manner. Near the outflow-side small openings, the pellets are completely melted at the highest temperature and are polled in the cylinder as molten resin.

Thus, according to the present invention, the melting device has melting holes each with a narrowed tip end in the device main body. As the multiple pellets pressed from the pellet storage area of the cylinder are inserted into the inflow-side large openings at the large opening side of the many melting holes with narrowed tip ends heated at the melting temperature by the heating unit, the pellets are melted in balance and as the melting device has large heat capacity, it is able to be kept at the high temperature. With this structure, the melting is accelerated with higher melting speed and the molten resin is pooled at the outlet member side.

Particularly, in the melting device, the temperature of resin is maximized at the outflow-side small openings by the heating unit. As the temperature of resin is optimized and maximized just before injection, it is possible to minimize the time duration where the resin is in the high-temperature state and also possible to prevent the resin from being deteriorated, thereby resulting in molding of high quality. That is, the melting device is configured to be able to increase the temperature of the resin to be optimal in the last stage of resin melting and just before injection.

Until the resin is injected into the adapter, the melting device is once heated to the high temperature by the heating unit and the high temperature is kept by the large heat capacity. Then, the melted pellets are also kept at sufficiently high melting temperatures without being decreased in temperature, thereby resulting in production of molten resin from pellets of excellent quality. When the molten resin is injected into the adapter, the resin is immediately solidified by circumferential walls or the like of the first and second members at ordinary temperatures thereby to be able to bond the first and second members to each other speedily and airtightly. Such solidification speed is different from that of a bond or joint member.

According to the second aspect, if the connection holes are formed respectively in the first and second members, the resin bonding is able to be completed instantaneously by the operation of injecting molten resin into the connection holes via the adapter. In the case of hard synthetic resin, bonding can be strengthened. Further, the adapter is implemented with a simple structure, thereby enabling inexpensive manufacturing.

According to the third aspect, if the connection hole of the first member or the second member is formed as a female screw, the present invention is able to be implemented as a resin bolt bonding structure advantageously.

According to the fourth aspect, as the connection holes are formed respectively in the first and second members and the recess parts are provided for forming bulges parts of larger diameter than the diameter of the connection holes, it is possible to perform rivet-like bonding simply and speedily.

According to the fifth aspect, particularly, if the second adapter is omitted and the connection hole of the second member is formed as a female screw, the present invention is able to be implemented as a resin bolt bonding structure. Besides, if a metal bolt of the second member is installed, the present invention is able to be implemented as a resin nut (hexagon cap nut) bonding structure.

According to the sixth aspect, if any connection hole is not provided in the first and second members, it is possible to bond the first and second member to each other. Even when the first and second members are bonded with a given space therebetween, it is possible to achieve favorable bonding. Bonding is, of course, possible when the first and second members are plate materials, and bonding is also possible even when the first and second members are round bars or square bars.

According to the seventh aspect, as the gate pin structure is used, it is possible to define the boundary between the nozzle part and the injected molten resin clearly, which brings about the effect of enabling resin bonding in an orderly manner. The same effect is also achieved in the eighth aspect.

According to the ninth aspect, particularly when the plural resin melting injection devices are arranged, they are able to be used as a plurality of hot runners with a corresponding number of nozzle parts, which produces a merit of enabling large-scaled resin bonding simply and speedily. That is, the resin connectors or the like are able to be configured in the front and back surfaces of the first and second members. According to the tenth aspect, when the melting device is of fixed type, the pellets melt, while, molten resin is injected from the tip end of the outlet member. With this structure, it is possible to perform melting and injection almost together.

### BRIEF DESCRIPTION OF DRAWINGS

FIG. 1 shows a side view illustrating a whole device with a movable melting device (melting device movable type) of the present invention, including a partial cross sectional view.

FIG. 2 shows (A) a longitudinal cross sectional view of the melting device movable type of the present invention immediately before injection; and (B) a longitudinal cross sectional view of the melting device movable type of the present invention immediately after injection.

FIG. 3 shows (A) a longitudinal cross sectional view of the melting device movable type of the present invention at the initial position in the melting step; and (B) a longitudinal cross sectional view of the melting device movable type of the present invention at the finish position in the melting step.

FIG. 4 shows (A) an enlarged longitudinal cross section view of a cone-shaped melting hole in which pellets move, melting, from an inflow-side large opening to an outflow-side small opening; and (B) an enlarged longitudinal cross section view of a melting hole with a narrowed end in which pellets move, melting, from an inflow-side large opening to an outflow-side small opening).

FIG. 5 shows (A) an enlarged cross sectional view illustrating completion of bonding of a first member and a second member with use of an outlet member and an adapter according to the first embodiment; (B) a perspective view of main members used in (A), including a partial cross sectional view; and (C) an enlarged cross sectional view illustrating completion of bonding of another first member and another second member with use of the outlet member and the adapter according to the first embodiment).

FIG. 6 shows (A) an enlarged cross sectional view illustrating completion of bonding of a first member and a second member with use of the outlet member and an adapter according to a modification to the first embodiment; (B) a perspective view of a second adapter; (C) a perspective view of a resin screw that is molded using the second adapter in (B); (D) a perspective view of a second adapter according to another embodiment; and (E) a perspective view of a resin screw that is molded using the second adapter in (D).

FIG. 7 shows (A) an enlarged cross sectional view illustrating completion of bonding of a first member and a second member with use of the outlet member and an adapter according to the second embodiment; (B) a perspective view of main members used in (A), including a partial cross sectional view; and (C) an enlarged cross sectional view illustrating completion of bonding of a first member and a second member with use of the outlet member and an adapter according to a modification to the second embodiment.

FIG. 8 shows (A) an enlarged cross sectional view illustrating completion of bonding of a first member and a second member with use of the outlet member and an adapter according to a third embodiment; and (B) a perspective view thereof.

FIG. 9 shows an enlarged cross sectional view illustrating completion of bonding of a metal nut-mounted first member and a second member with use of the outlet member and an adapter according to a modification to the third embodiment,

FIG. 10 shows (A) an enlarged cross sectional view illustrating completion of bonding of a first member and a second member with use of the outlet member and an adapter according to a fourth embodiment; and (B) a perspective view thereof.

FIG. 11 shows an enlarged cross sectional view illustrating completion of bonding of a metal bolt-mounted first member and a second member with use of the outlet member and an adapter according to a modification to the fourth embodiment.

FIG. 12 shows (A) an enlarged cross sectional view illustrating completion of bonding of first and second members according to another embodiment with use of the outlet member and the adapter according to the first embodiment; and (B) an exploded perspective view of the first and second members according to the other embodiment in (A).

FIG. 13 shows (A) an enlarged cross sectional view illustrating completion of bonding of first, second and third members according to yet another embodiment with use of the outlet member and the adapter according to the first embodiment; and (B) an exploded perspective view of the first, second and third members according to the other embodiment (A).

FIG. 14 shows (A) an enlarged cross sectional view illustrating completion of bonding of a first member and a second member with use of the outlet member and an adapter according to a fifth embodiment; (B) a perspective view of the first and second member manufactured by the manufacturing device in (A) and solidified resin; (C) an enlarged cross sectional view illustrating completion of bonding of a first member and a second member with use of the outlet member and an adapter according to a modification to the fifth embodiment; and (D) a perspective view of the first and second member manufactured by the manufacturing device in (C) and solidified resin.

FIG. 15 shows (A) an enlarged cross sectional view illustrating completion of narrow-hole bonding of a first member and a second member with use of the outlet member and an adapter according to a modification to the first embodiment; and (B) a perspective view of main members used in (A), including a partial cross sectional view.

FIG. 16 shows an enlarged cross sectional view illustrating completion of bonding of a first member and a second member with use of the outlet member and an adapter according to a sixth embodiment.

FIG. 17 shows (A) an enlarged cross sectional view illustrating completion of bonding of a first member and a second member with use of the outlet member and an adapter according to the sixth embodiment; (B) a perspective view of the first and second member manufactured by the manufacturing device in (A) and solidified resin; (C) an enlarged cross sectional view taken along the line Y1-Y1 in (B); (D) an enlarged cross sectional view taken along the line X1-X1 in (B); and (E) a perspective view of the second adapter.

FIG. 18 shows (A) a longitudinal cross sectional view of a melting device fixed type of the present invention immediately before injection; and (B) a longitudinal cross sectional view of the melting device fixed type of the present invention immediately after injection.

FIG. 19 shows (A) an enlarged longitudinal cross sectional view of the melting device and an the opening and closing valve part according to the first embodiment; (B) an exploded perspective view of (A), partially omitted here; (C) an enlarged view of the (a) part in (B); (D) a cross sectional view taken along the line X2-X2 in (A); and (E) a perspective view of an opening and closing valve according to another embodiment.

FIG. 20 shows (A) an enlarged longitudinal cross sectional view of the melting device and the opening and closing valve part according to the second embodiment; and (B) an enlarged longitudinal cross sectional view of the melting device and an the opening and closing valve part according to the third embodiment.

FIG. 21 shows (A) an enlarged longitudinal cross sectional view of the melting device and an the opening and closing valve part according to the fourth embodiment; (B) a partial perspective view of an upper part of the melting device according to a modification of (A); (C) an enlarged cross sectional view taken along the line X3-X3 in (B); and (D) an enlarged cross sectional view taken along the line Y2-Y2 in (C).

FIG. 22 shows (A) a cross sectional view of a gate pin configuration of an outlet member part; (B) an enlarged view of the (β) part in (A); and (C) a cross sectional view taken along the line Y3-Y3 in (A), including a partial side view.

FIG. 23 is a simplified view illustrating an image of the present invention provided in a robot arm.

### DESCRIPTION OF EMBODIMENTS

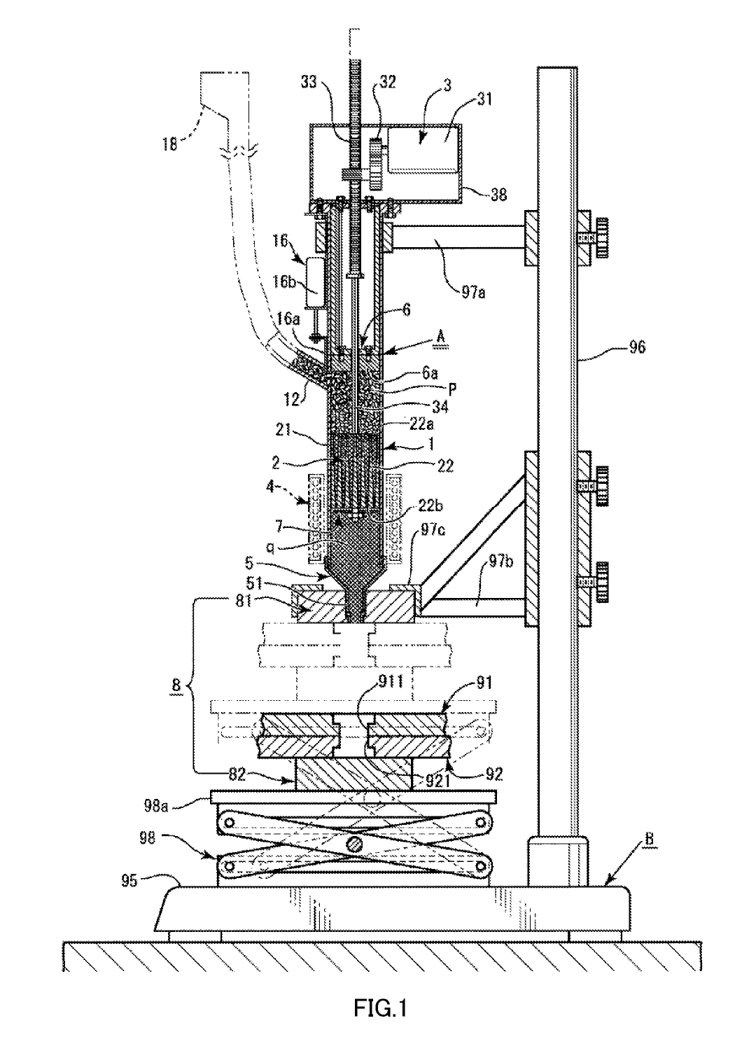

With reference to the drawings, embodiments of the present invention will be described below. As illustrated in FIG. 1, the present invention is principally configured with a resin melting injection device A for injecting melting resin q and an adapter 8. This resin melting injection device A and the adapter 8 constitute a rein bonding device for bonding a first member 91 and a second member 92 to each other.

Materials of the first member 91 and the second member 92 may be metal, glass, resin, timber or the like, and generally, they are often metal. The material of the first member 91 and the material of the second member 92 are often the same, but may be different depending on the use application. That is, they are aluminum and iron, iron and plastic, or the like.

Since the resin bonding device according to the present invention has high injection performance, there is a wide variety of available materials from low-temperature melting resin (general-purpose plastic, ABS, polyethylene, polypropylene and so on) to high-temperature melting resin (engineering plastic, polyamide, polycarbonate, polyimide and so on) and various materials are selectable depending on the use application. Colors are also selectable appropriately depending on the product.

The resin melting injection device according to the first embodiment has a movable stopper 6, as illustrated in FIGS. 1 to 3. The resin melting injection device A is configured to mainly have a cylinder 1, a melting device 2 for melting pellets p, p, a drive unit 3 for moving the melting device 2 in a reciprocating manner and a heating unit 4.

As illustrated in FIG. 1, the resin melting injection device A is fixed to an end of an upper clip part 97a that is provided on a column part 96 on a base 95 of a small-sized stand B (about 0.5 m to 1 m), and the upper clip part 97a is adjustable in the vertical direction. The resin melting injection device A is also supported at an outlet member 5 below the cylinder 1 by a fixation frame 97c for supporting an upper adapter 81 around (described later) provided at the tip end of a lower clip part 97b. Particularly, the lower clip part 97b and the fixation frame 97c are configured to resist pressure from the bottom.

As illustrated in FIG. 1, a lower adapter 82 is fixed onto a seat 98a of an elevator unit 98, and the first member 91 and the second member 92 are mountable on this lower adapter 82. When the elevator unit 98 moves up appropriately, the lower adapter 82 coincides with the upper adapter 81 to keep the first member 91 and the second member 92 under pressure. During this state, molten resin q is injected from the resin melting injection device A. In the following description, as the resin melting injection device A has features, the configuration of the resin melting injection device A is described first and the adapter 8 will be described thereafter.

At the end of the cylinder 1 (lower end in figures) of the resin melting injection device A, the outlet member 5 is provided, and inside the outlet member 5, there are provided a stopper part 6 and the melting device 2 moving in a reciprocating manner. The inside of the stopper part 6 is formed like a cylinder, and at the tip end (lower end in figures), a plate-shaped stopper surface 61 is provided to be slidable on the inner surface of the cylinder 1 so as to provide a sealing state. The drive unit 3 of the melting device 2 is provided with a reciprocating motion bar 34. All over the stopper surface 61, there may be provided a heat insulating material 61a made of synthetic resin.

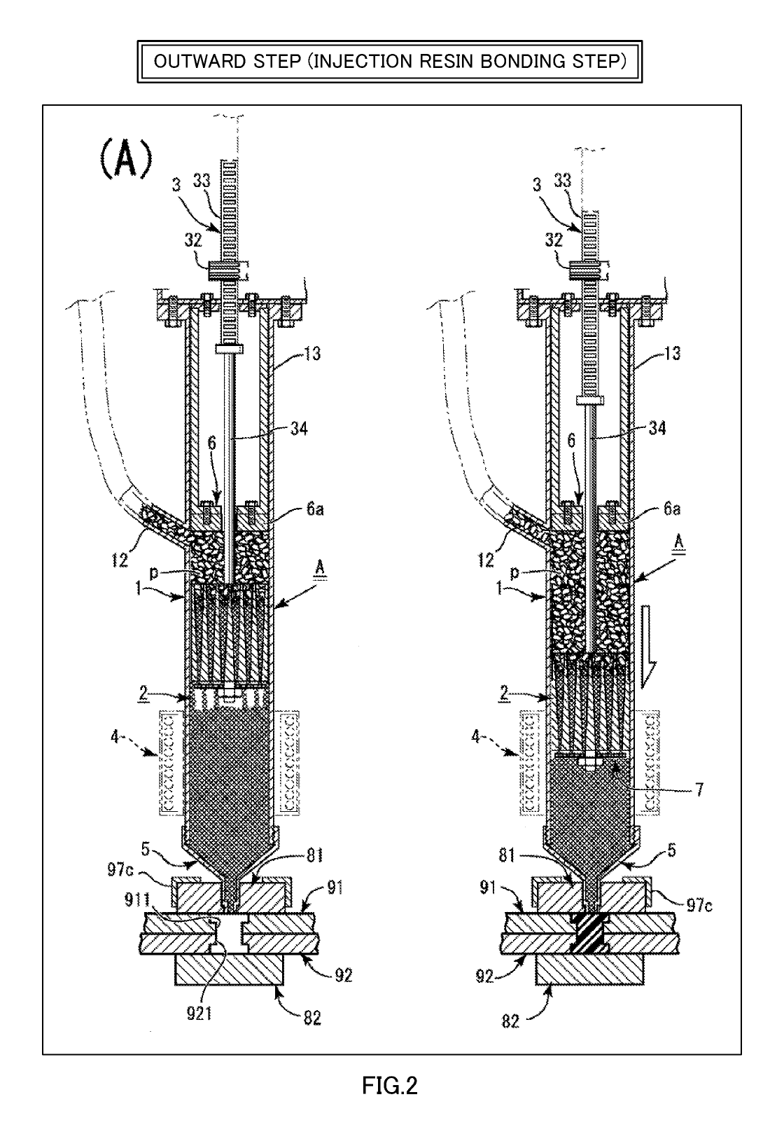

In other words, the outlet member 5 is mounted on the one-end side (lower end in FIG. 1) in the axial direction (this direction may be called “longitudinal direction” and denotes the up-and-down direction in FIGS. 1 and 2((A) and (B))) of the cylinder 1, and the stopper part 6 as the cylinder is provided at the other end side (upper end in FIG. 1(A)) in the axial direction (upper end in the longitudinal direction). Besides, at the other end (upper end in FIGS. 1((A) and 1(B))) in the axial direction (upper end in the longitudinal direction), the drive unit 3 is mounted on the cylinder 1 via a cylindrical case 13. The drive unit 3 is used to cause the melting device 2 to move in a reciprocating manner (see FIGS. 1 and 2).

As for a material of the cylinder 1, it needs to be heated quickly and is preferably iron or stainless steel containing iron in large amounts. The cylinder 1 is configured to have a cylinder main body 11 that is formed in an elongated shape, and a tubular supply tube 12 that is connected from a pellet supply opening 11a formed near the stopper part 6.

The supply tube 12 is formed to communicate with a hopper 18 where pellets p, p are stored. The supply tube 12 is connected to the hopper via a part that is formed integral with the cylinder 1 and a pipe appropriately formed in an arc shape. The cylinder main body 11 is a cylindrical member and has an approximately column-shaped space surrounded by an inner-circumferential side surface part 11b.

The thickness of the cylinder main body 11 is preferably about 2 mm. The hopper 18 is able to store a large number of pellets p, p and the charged pellets p, p are conveyed via the supply tube 12 and the pellet supply opening 11a to the cylinder main body 11.

Though it is not illustrated specifically, the pellets p, p may be press-charged to the supply tube 12 by a screw or an air pressure device. The cross section of the cylinder 1 is a circle, but may be a distorted circle or ellipse. In such a case, accurate reciprocating movement is possible without rotating the melting device 2 of the same shape.

At one end side (lower end) in the axial direction (longitudinal direction) of the cylinder main body 11, the outlet member 5 is mounted. The outlet member 5 is configured with a nozzle part 51, a funnel part 52 and a connecting part 53. The nozzle part 51 is formed of an injection outlet end 51a and a base part 51b (see FIGS. 1 and 5(A)).

The injection outlet end 51a is formed narrow with a small diameter, and the base part 51b is formed with a larger diameter with a step provided between the injection outlet end 51a and the base part 51b. In the first adapter 81 of the adapter 8, an insertion hole 81a is formed to have the nozzle part 51 fit therein. The connecting part 53 of the outlet member 5 is formed to have a screw structure (outer screw, inner screw) thereby to be detachable from the cylinder main body 11. The material of the nozzle part 51 preferably has excellent heat conductivity and is desired to be, specifically, beryllium copper or copper.

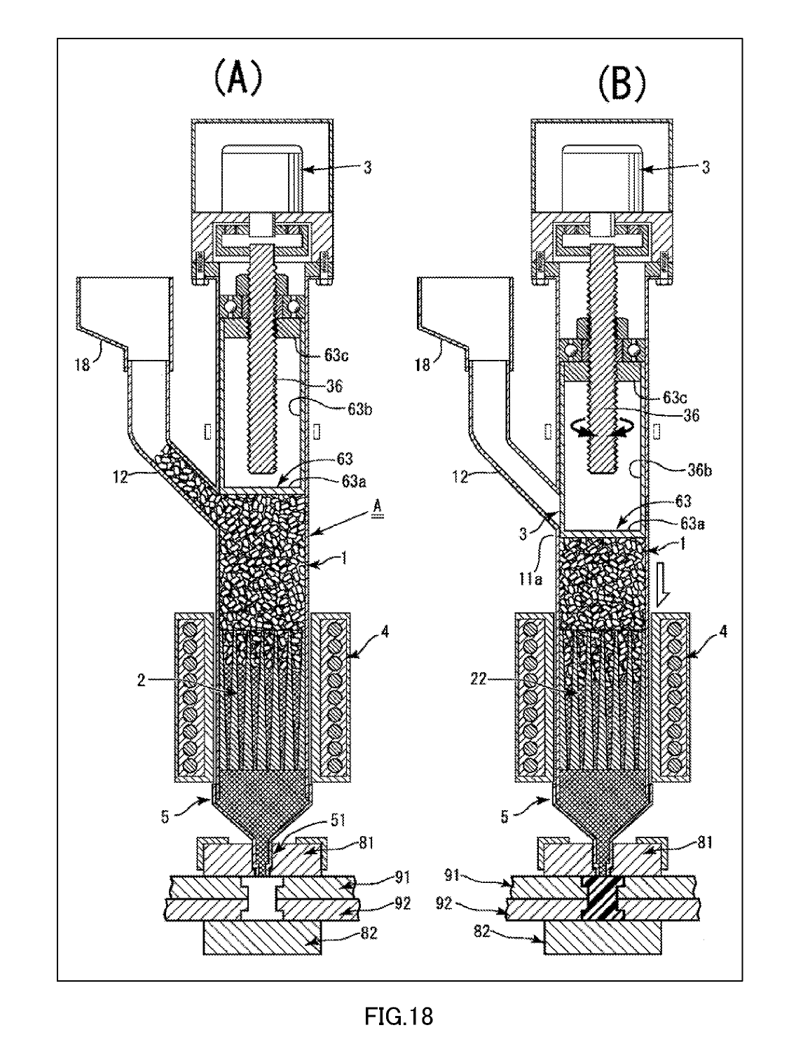

The melting device 2 has an approximately cylindrical device main body 21 in which a large number of melting holes 22, 22 are formed (see FIGS. 1-3 and 18-21). The material of the device main body 21 is preferably a material having large heat capacity and excellent heat conductivity. Specifically, it is copper or beryllium copper. the device main body 21 is formed to be movable in an reciprocating manner (see FIGS. 1 to 3) or fixed (see FIG. 18) inside the cylinder main body 11 of the cylinder 1 and is generally located near the outlet member 5 (see FIG. 1(A)).

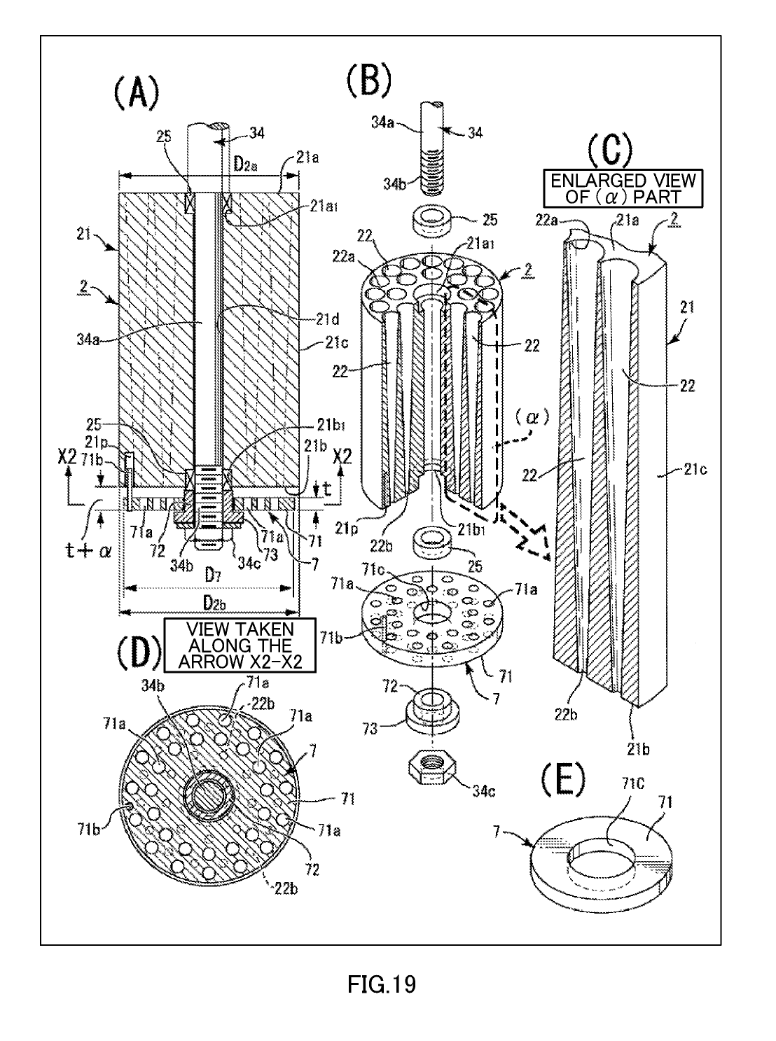

As illustrated in FIG. 19, the device main body 21 of the melting device 2 is formed in a cylindrical shape as described above, in which a surface at the side where it faces the stopper part 6 and a large amount of pellets p, p inflow is called inflow-side surface part 21a. A surface opposite to the inflow-side surface part 21a where it faces the outlet member 5 and molten resin q outflows is called outflow-side surface part 21b.

An outer circumferential side surface of the device main body 21 is called circumferential side surface 21c. As described above, the device main body 21 is an accurate cylindrical shape such that the diameter D2a of the inflow-side surface part 21a is equal to the diameter D2b of the outflow-side surface part 21b at any position in the axial direction of the circumferential side surface 21c (see FIGS. 19((A) and (B))). In addition, the melting device 2 as shown in FIGS. 1 to 3 and 19 is also formed in an accurate cylindrical shape as described above.

That is, the following equation is satisfied (see FIG. 19(A)):

D2a=D2b

Next, the melting holes 22 are formed in the axial direction (longitudinal direction) of the device main body 21 (see FIGS. 1 to 3). More specifically, the melting holes 22 are tunnel-shaped or tubular through holes in a cone shape (see FIGS. 19((B) and (C))). In the melting holes 22, the above-mentioned cone-shaped through holes are formed such that the cross section orthogonal to the hole forming direction becomes smaller and smaller, and specifically, each hole has a circular cone-shaped or pyramid air space (see FIGS. 19((B) and (C))).

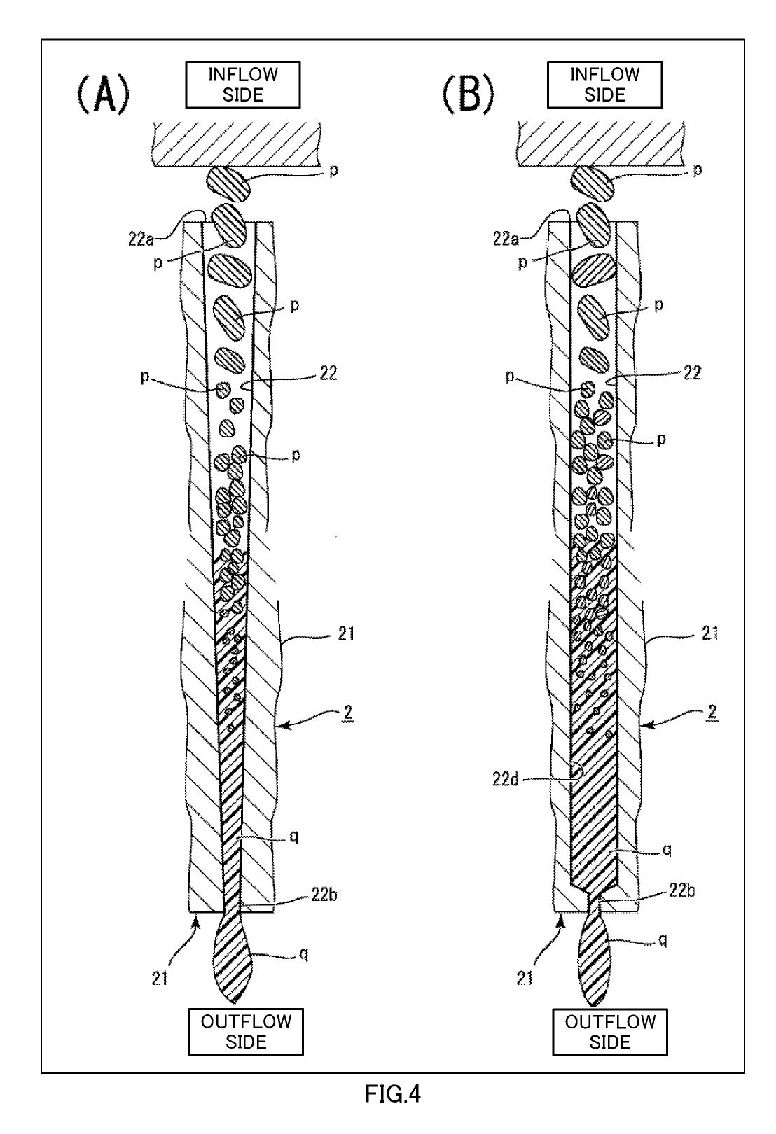

In the present invention, the cone shape of each melting hole 22 is preferably a circular cone and the diameter of the melting hole 22 is formed to be gradually smaller (see FIGS. 19((B) and (C))). As described above, as the melting hole 22 is a hole having a cone-shaped air space, the openings at both ends of the melting hole 22 are different in size. Then, the large opening side of each melting hole 22 is called inflow-side large opening 22a where the pellets p, p inflow (see FIGS. 4((A) and (B)) and 19((B) and (C))).

Besides, the small opening side of each melting hole 22 is called outflow-side small opening 22b (see FIGS. 4(A) and 16((B) and (C))). That is, the melting hole 22 is a channel communicating from the inflow-side large opening 22a to the outflow-side small opening 22b and the cross section becomes smaller from the inflow-side large opening 22a to the outflow-side small opening 22b. [0060]

Then, the inflow-side large opening 22a is located at the inflow-side surface part 21a of the device main body and faces (is opposite to) the stopper part 6 (see FIG. 1). In addition, the outflow-side small opening 22b is located at the outflow-side surface part 21b and faces (is opposite to) the outlet member 5 (see FIG. 1).

As described above, inflow-side large openings 22a, 22a of a large number of melting holes 22, 22 are arranged in the inflow-side surface part 21a of the melting device 2. In the inflow-side surface part 21a, as it faces the stopper part 6 and the pellets p, p flow into the inflow-side large openings 22a, the inflow-side surface part 21a is called inflow side of the melting device 2.

In addition, as illustrated in FIGS. 19 to 21, outflow-side small openings 22b, 22b of a large number of melting holes 22, 22 are arranged in the outflow-side surface part 21b of the melting device 2. In the outflow-side surface part 21b, as it faces the outlet member 5 and molten resin q obtained by melting the pellets p, p outflow from the outflow-side small openings 22b, 22b, the outflow-side surface part 21b is called outflow side of the melting device 2. The melting state of the melting device 2 toward the inflow side and the outflow side are illustrated in FIGS. 4((A) and (B)).

When each melting hole 22 is a cone-shaped hole, the cross sectional shape orthogonal to the axial direction (longitudinal direction) is a round shape at any position (see FIGS. 19((B) and (C))). Then, the inflow side large opening 22a of each melting hole has such a size that the whole of one pellet p can be inserted into the melting hole 22 or at least a part of the pellet p can be inserted into the melting hole 22. As for the specific size of the inflow-side large opening 22a, the diameter is such that pellets p, p can be easily inserted and is about 3 to 4 mm.

Each outflow-side small opening 22b has such a diameter that molten resin q obtained by melting the pellets p, p into liquid can flow, which diameter is about 1 to 1.5 mm. The melting hole 22 has a cross section along the axial direction (longitudinal direction) that is in an approximately tapered shape. That is, it is a cone shape along the axial direction (longitudinal direction), and if it is in a pyramid shape, the shape may be quadrangular pyramid or triangular pyramid. Or, a combined shape of the quadrangular pyramid and triangular pyramid may be used as well. The melting holes 22 of this type are such that the inflow-side large openings 22a of the cone-shaped melting holes 22 are formed in a polygonal shape more than triangular shape and the outflow-side small openings 22b are in a round shape.

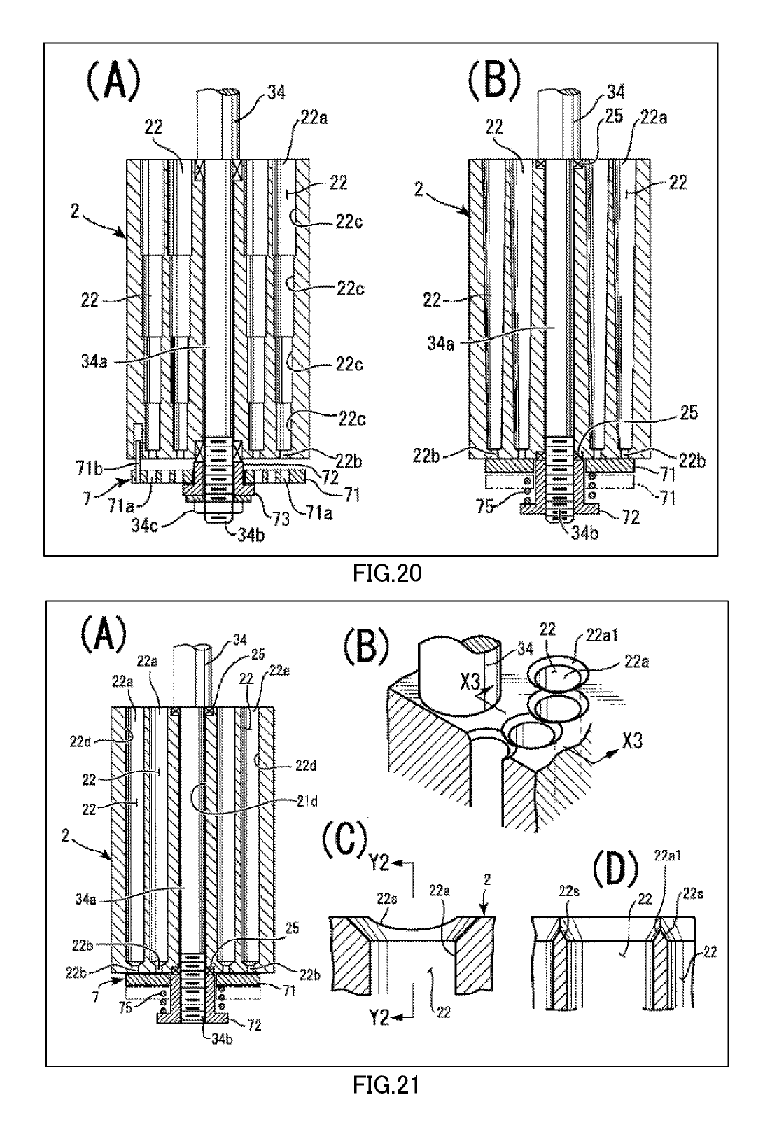

FIGS. 20((A) and (B)) illustrate other embodiments of the melting holes 22 of the melting device 2 that are each formed narrower at an end. FIG. 20(A) illustrates the second embodiment of melting holes 22 of the melting device 2, in which each inflow-side large opening 22a is formed of a plurality of cylindrical parts 22c, 22c and its diameter becomes smaller and smaller from the inflow-side large opening 22a to the outflow-side small opening 22b. An end of a cylindrical part 22c corresponds to the outflow-side small opening 22b or an end is only formed as the outflow-side small opening 22b (see FIG. 20(A)).

FIG. 20(B) also illustrates melting holes 22 that are each formed narrower at an end. This is the third embodiment of the melting holes 22 of the melting device 2 and each melting hole is a cone-shaped hole such that the diameter is gradually changed from a large size at the inflow-side large opening 22a to a middle size at the outflow-side small opening 22b and only an end is formed as the outflow-side small opening 22b.

FIG. 21(A) also illustrates melting holes 22 that are each formed narrower at an end. This is the third embodiment of the melting holes 22 of the melting device 2 and each melting hole is formed such that a large-diameter cylindrical part 22d as the inflow-side large opening 22a is formed close to an end and the end is only formed as the outflow-side small opening 22b.

In FIG. 21(B), the inflow-side large opening 22a of each melting hole 22 has a round cross section and the inlet part of the inflow-side large opening 22a may be chamfered to be a plate-shaped chamfered part 22a1 and the boundary parts of plate-shaped chamfered parts 22a1, 22a1 of adjacent inflow-side large openings 22a, 22a may be formed like teeth 22s. Due to these teeth 22s, the pellets p, p are likely to be broken into small pieces and separated from each other by the teeth 22s so that the pellets p, p are easily inserted into the inflow-side large openings 22a, 22a thereby to accelerate melting of the pellets p, p.

The drive unit 3 is formed of a motor drive part 31 equipped with a reducer, pinion gear 32 and a rack shaft 33. Or, though it is not shown, it may be a drive unit 3 for moving a rod in a reciprocating manner by driving of a motor drive part 31 equipped with a reducer and a ball screw and ball screw nut driving. An end of the rack shaft 33 or the rod end is connected to a reciprocating motion bar 34.

As illustrated in FIG. 1, the reciprocating motion bar 34 passes through the stopper part 6 approximately in the center and is connected at the end to the melting device 2. The rear part of the rack shaft 33 is fixed to a motor case of the motor drive part 31. The reciprocating motion bar 34 is made of iron, stainless steel or the like.

The motor drive part 31 is formed of a brushless motor, stepping motor or the like and is able to perform drive control with high accuracy and to control the time of the melting step and the time of the injection step of molten resin q separately in consideration of the material of pellets. Consequently, it is possible to assure sufficient time for resin melting and complete the injection step of its molten resin q efficiently and extremely rapidly and for a short time.

For example, by setting the time of the melting step to about 30 to 60 seconds and the time of the injection step of molten resin to about 1 second, there is produced an advantageous effect of being able to complete the injection and resin bonding process efficiently and extremely quickly and for a short time. Particularly, use of the brushless motor is preferable for setting the time of the melting step to be longer and controlling the time of resin bonding repeatedly and accurately.

The heating unit 4 is a member for heating the melting device 2 from the outer surface of the cylinder main body 11. The heating unit 4 is formed into a tubular shape to exhibit excellent heat conductivity to the melting device 2. Specifically, the heating unit 4 may be an IH heater in a wound shape to exhibit a sufficient amount of heat.

The heating unit 4 serves to heat the melting device 2 that moves in a reciprocating manner inside the cylinder main body 11 inside the cylinder 1. Specifically, the heating unit 4 is preferably an electromagnetic induction, that is, IH (induction heating) coil, and the heating unit 4 is formed by winding IH coil around a resin or ceramic heat insulating coil bobbin.

The shape of the bobbin is configured such that the distance between the IH coil and the outer side surface of the cylinder main body 11 becomes optimal. Input power is preferably variable from 0 to 1 Kw by a controller. The cylinder 1 is equipped with a thermocouple so that the temperature of the cylinder 1 is able to be set to an appropriate value. As another type of the heating unit 4, a band heater may be used. The heating unit 4 is not limited to the unit described above and may be any heating unit as far as it is able to be used in the present invention.

The heating unit 4 is fixedly mounted on the cylinder main body 11 and is configured to hold the heat source sufficiently in terms of the heat amount of the melting device 2 even if it moves in a reciprocating manner by drive unit 3. This is because, the heating unit 4 is generally set at the position shown in FIG. 1(A), that is, at the fixed position close to the outlet member 5. In the pellet storage area W, if the melting device 2 moves backward (return travel) (melting step), it quickly moves from that state to the outward travel (injection step) so that the melting device 2 is not easily cooled from the heating state and a sufficient amount of heat is able to be achieved to keep a predetermined temperature.

Further, the melting device 2 is provided with a heat insulation process according to need, which is described specifically below. The reciprocating motion bar 34 of the drive unit 3 is inserted movably in a center through hole 21d that passes through the centers of the outflow-side surface part 21b and the inflow-side surface part 21a of the melting device 2. That is, the inner diameter of the center through hole 21d is formed to be slightly larger than the diameter of the reciprocating motion bar 34 and not in contact with the reciprocating motion bar 34. Further, at the center positions of the outflow-side surface part 21b and the inflow-side surface part 21a of the melting device 2, recesses parts 21a1 and 21b1 are formed.

In the recesses parts 21a1 and 21b1, there are arranged circular plate shaped support pieces 25, 25 made of a ceramics or polyimide heat insulating material. The support pieces 25, 25 are fixed to the reciprocating motion bar 34. Specifically, first, one of the support pieces 25, 25 is inserted onto the reciprocating motion bar 34, and then, the tip end side of the reciprocating motion bar 34 passes through the center through hole 21d of the melting device 2. Then, the one support piece 25 is arranged in the recess part 21a1 of the inflow-side surface part 21a of the melting device 2.

In this state, the other support piece 25 and a circular plate 71 are fit onto a collar member 72, which is then fit on a tip-end side small-diameter part 34a of the reciprocating motion bar 34. The collar member 72 is made from iron, stainless steel or the like. Besides, a nut 34c is fit on a screw part 34b of the tip-end side small-diameter part 34a of the reciprocating motion bar 34 thereby to fix the melting member 2 to the reciprocating motion bar 34. That is, the melting device 2 is fixed to the reciprocating motion bar 34 via the support pieces 25, 25 out of direct contact with the reciprocating motion bar 34. Therefore, the reciprocating motion bar 34 is able to be in such a heat insulation state that it receives almost no heat from the melting device 2.

With this configuration, the heat source generated in the melting device is configured not to be transferred to the reciprocating motion bar 34 made of metal (mainly, stainless steel) inside the cylinder 1. Thus, heat insulation of the melting device 2 is achieved for the purpose of using heat of the melting device 2 only for melting of the pellets p, p in melting. Accordingly, the heat insulating member (support pieces 25 or cylindrical collar 35) is provided between the melting device 2 and the reciprocating motion bar 34.

In particular, when the diameter of each outflow-side small opening 22b Of the melting device 2 is much smaller than the diameter of the inflow-side large opening 22a (see FIGS. 1 to 3), for example, it is about 1 mm, if the molten resin q is pressed via the outlet member 5 by the outward travel of the drive unit 3, the surface area of the outflow-side surface part 21b of the melting device 2 is much larger than the total area of the outflow-side small openings 22b, the rate of the molten resin q flowing backward from the outflow-side small openings 22b becomes extremely small and the molten resin q can be pressed to be injected from the outlet member 5 in good condition. Thus, the injection step of the melting resin q may be performed with no opening and closing valve 7 provided in the melting device,

As the internal configuration of the melting device 2, an opening and closing valve 7 is provided where necessary (see FIGS. 1 to 3). That is, the opening and closing valve 7 is provided to open the inflow-side large openings 22a or outflow-side small openings 22b of the melting device 2 in the return step and close the inflow-side large openings 22a or outflow-side small openings 22b of the melting device 2 in the outward step.

Specifically, the opening and closing valve 7 is configured to close the tip end of the melting device in the outward step, or release (open) it in the return travel. More specifically, the opening and closing valve 7 is formed of a circular plate 71 and the collar member 72 with a collar 73. The collar member 72 with collar 73 is located in front of the outflow side surface part 21b of the melting device 2 and the opening and closing valve 7 is provided at the tip end of the reciprocating motion bar 34 to be slightly movable between the collar 73 and the outflow-side surface part 21b, via the collar member 72.

The diameter D7 of the circular plate 71 is formed to be smaller than the diameter D2b of the outflow-side surface part 21b (see FIG. 16(A)). That is, the following expression is satisfied:

D7<D2b(=D2a)

This is because in the return step, the molten resin q is able to flow more easily than on the outer circumferential part of the opening and closing valve 7.

The above-mentioned structure is explained simply below. The opening and closing valve 7 is provided between the outlet member 5 and the melting device 2 and the opening and closing valve 7 is configured to have a circular plate 71 moving close to or away from the outflow-side small opening 22b of the melting device 2. The circular plate 71 is formed to have a smaller diameter than the diameter of the melting device 2.

In the circular plate 71 in the opening and closing valve 7, a plurality of through holes 71a is formed as illustrated in FIGS. 19 ((B) and (D)), and the through holes 71a are formed not to match the positions of the outflow-side small openings 22b of the melting device 2 and a guide pin 71b provided jutting from the circular plate 71 is provided to be freely inserted in a hole part 21p formed in the melting device 2.

In another embodiment of the opening and closing valve 7, as illustrated in FIG. 19(E), the plural through holes 71a are eliminated from the circular plate 71. That is, the circular plate 71 is a plate with no hole and the diameter of the circular plate 71 is smaller than the diameter of the melting device 2. In this embodiment, in the return travel, the molten resin q all flows on the outer circumferential part of the opening and closing valve 7.

In the injection step, when the melting device 2 equipped with the opening and closing valve 7 charges molten resin q into the die, particularly, the molten resin q inside the outlet member 5 becomes under high pressure and may flow backward. Therefore, the opening and closing valve 7 is configured to be always under elastic pressure by an elastic member 75 as compression spring.

In another embodiment of the circular plate 71 of the opening and closing valve 7, though it is not shown, the circular plate 71 may be configured such that it is configured to have the same diameter as the diameter D2b of the outflow-side surface part 21b of the melting device 2 and notches are formed at plural points (for example, four points) on the circumferential edge of the circular plate 71. Each notch is formed in a U shape or horizontal U shape.

In the collar member 72 illustrated in FIG. 19(A), an inner screw is formed at the inside that fits to the screw part 34b of the tip-end side small-diameter part 34a. With this structure, the collar member 72 is fit on the tip-end side small-diameter part 34a so that the reciprocating motion bar 34 is fixed to the melting device 2 without the nut 34c being fit on the screw part 34b, as illustrated in FIG. 19(A) (see FIGS. 20(B) and 21(A)).

With the thus-configured collar member 72 and opening and closing valve 7, the circular plate 71 is configured to be able to move close and away between the collar 73 of the collar part 72 and the melting device 2. Specifically, assuming the thickness of the circular plate 71 is t, the distance between the collar and the surface of the melting device becomes thickness t+a, and the above-mentioned movement of the circular plate 71 is enabled within the range of a (see FIG. 19(A)). This movement is also enabled when the elastic member 75 is provided as a compression spring.

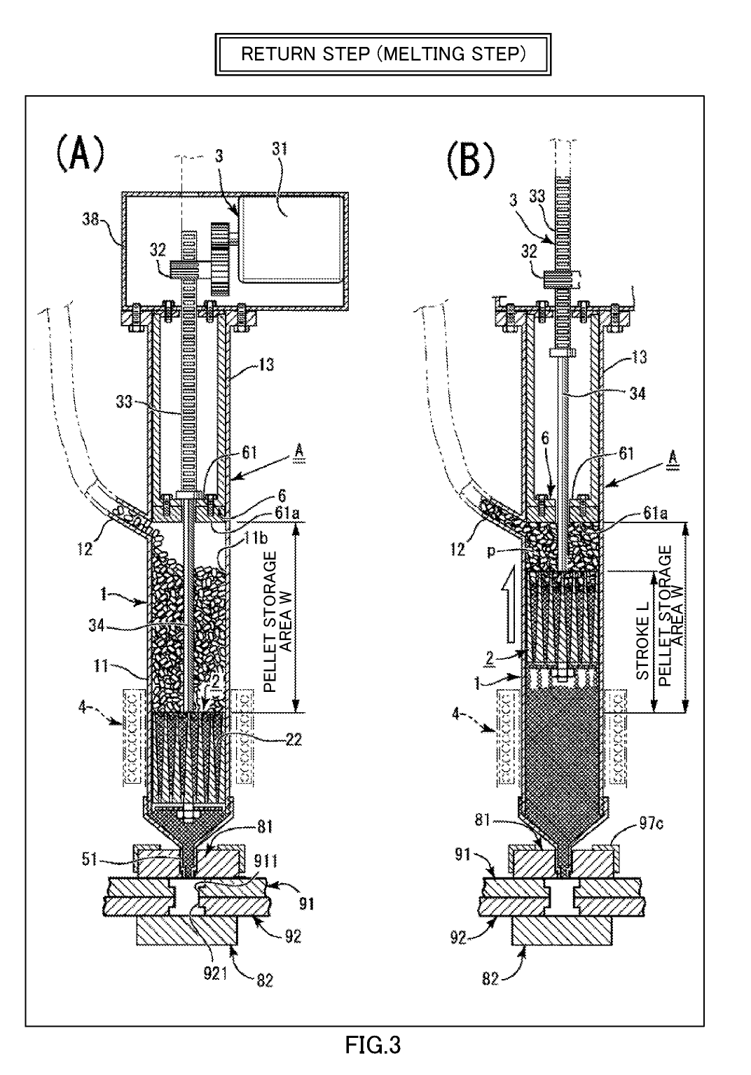

Next description is made about the pellet melting step and theory. First, before the melting step, as illustrated in FIG. 3(A), in the pellet storage area W in the cylinder 1, pellets p, p are charged from the pellet supply opening 11a and are stored in front of the inflow-side surface part 21a of the melting device 2. The pellet storage area W is provided in the cylinder 1 between the rear part of the melting device 2 when the injection step is finished and the stopper part 6. The pellet supply opening 11a is provided at the rear position in the pellet storage area W.

Then, when the melting step is set ON, the return step starts by the drive unit 3 and many pellets p, p in the pellet storage area W are compressed between the inflow-side surface part 21a of the melting device 2 and the stopper part 6, as illustrated in FIG. 3(B). The pellets p, p also move to return to the hopper 8 side, but, actually, there occurs pressure f, f between the pellets p, p and the pellets p, p are brought into a pressed state, and the pellets p, p flow from many inflow-side large opening 22a, 22a into melting holes 22, 22 (see FIGS. 3(B), 4(A)). As described above, each inflow-side large opening 22a is formed in such a size that at least apart of each pellet p can be (partially) inserted into the inflow-side large opening 22a.

In general, the size of each inflow-side large opening 22a is such that a pellet p of average size is wholly inserted into the inflow-side large opening 22a (see FIG. 4(A)). The pellets p, p first inserted into the melting holes 22, 22 are pressed by following pellets p, p toward the outflow-side small openings 22b and the melting device 2 is kept at the temperature to melt the pellets by the heating unit 4.

Accordingly, the pellets p inserted from the inflow-side large openings 22a move from the inflow-side large openings 22a toward the outflow-side small openings 22b, while each pellet p melts toward its center (see FIG. 4(A)). Each pellet p is arranged such that when the pellet p is in an initial state where the pellet p begins to enter the inflow-side large opening 22a, the pellet p is surrounded approximately evenly by the inner circumferential wall surface of the melting hole 22.

Then, as the pellet p moves in the melting hole 22 toward the outflow-side small opening 22b, the pellet p is melted and its size is decreased gradually (see FIG. 4(A)). Although the pellet p moves toward the outflow-side small opening 22b while it is melting, the pellet p downsized by melting is kept evenly surrounded by the inner circumferential wall surface of the melting hole 22, as the melting hole 22 is also downsized gradually. Therefore, melting of the pellets p is performed speedily.

In other words, each pellet p is surrounded approximately evenly by the inner circumferential wall part of the melting hole 22 and is always kept close to or in contact with the inner circumferential surface part (see FIG. 4(A)). Then, as melting of the pellet p proceeds, the pellet p moves into a narrow part of the melting hole 22 so that melting of the pellet p is accelerated. As the pellet p is melt into liquid inside the melting hole 22, a following pellet p is promoted to melt by heat of already liquefied pellet pa (see FIG. 4(A)).

Further, as illustrated in FIGS. 20((A) and (B)), if the melting holes 22 are each formed to be narrower at the tip end by the cylindrical parts 22c, 22c, at the outlet side of each melting hole 22, the pellet is pressed and melted by a heating force so that the same operation as the cone-shaped melting hole 22 can be exhibited. Such formation of stepped holes is able to be performed inexpensively as compared with formation of cone-shaped holes.

Further, as illustrated in FIG. 21(A), if each melting hole 22 is formed such that the large-diameter cylindrical part 22d is formed as the inflow-side large opening 22a up to a point close to an end and the outflow-side small opening 22b is formed only at the outflow side, the pellets are pressed at the backside and is melted by a heating force so that the same operation as the cone-shaped melting holes can be exhibited (see FIG. 4(B)). Such hole formation is also able to be performed inexpensively.

Thus, as the pellets p moves from the inflow-side large openings 22a of the melting holes 22 toward the outflow-side small openings 22b, melting of the pellets is advanced, melting is completed near the outflow-side small openings 22b or just before the outflow-side small openings 22b, and the pellets are liquefied (see FIGS. 3(B) and 4((A) and (B))). The pellets p becomes completely liquefied molten resin q and are stored from the outflow-side small openings 22b in the cylinder 1, as illustrated in FIG. 2(A).

As described above, in the return step started by the drive unit 3, there occurs pressure f, f between the pellets p, p in the pellet storage area W, the pellets p, p are compressed, and each pellet p inserted from the inflow-side large opening 22a of the melting hole 22 is always surrounded by the inner circumferential wall surface of the melting hole 22 while it is moving toward the outflow-side small opening 22b. Therefore, the pellets p are melted by the heating unit 4, and as illustrated in FIG. 3(B), pressure is finished in stroke L and the molten resin q is stored in the cylinder 1 under the melting device 2.

As the plural pellets p, p are able to be melted only in almost required amount, the materials are prevented from being exposed to long-time, heat and mechanical stress in the cylinder main body 11. Accordingly, it is possible to produce resin products of high quality. In addition, the injection device of the present invention is high in melting efficiency and there is no need to charge the materials excessively, thereby achieving downsizing of the device and power saving and resource saving. Further, as the temperature becomes an injection optimum temperature and highest temperature at the melting final step just before the injection, it is possible to minimize the time duration of resin at high temperatures and thereby to produce resin molding of good quality.

In the above-described structure, the melting device 2 is of the movable type and the stopper part 6 is of the fixed type. However, the melting device 2 may be of the fixed type and the stopper part 6 may be of the movable type. In this embodiment, as illustrated in FIG. 18, a movable cylinder 63 as the stopper part 6 moves in a reciprocating manner within the cylinder main body 11 in the axial direction (in the longitudinal direction) by rotation of an outer screw shaft 36 provided in the drive unit 3 so as to transfer a large number of pellets p, p into melting holes 22 of the melting device 2. The movable cylinder 63 is formed of a pressure stopper surface 63a as a stopper surface, an outer peripheral surface part 63b and a rear side end part 63c.

By these pressure stopper surface 63a, outer peripheral surface part 63b and rear side end part 63c, the movable cylinder 63 is formed into a cylindrical shape. The movable cylinder 63 is configured not to rotate in its circumferential direction and is also configured to move in a reciprocating manner in the axial direction (longitudinal direction) by rotation of the outer screw shaft 36 (see FIGS. 18((A) and (B))). The structure to prevent rotation of the movable cylinder 63 is such a structure as to prevent the movable cylinder 63 from idle-running in its circumferential direction.

As described above, the movable cylinder 63 is configured only to move in the axial direction (longitudinal direction) in the cylinder main body 11 while being prevented from rotating in its circumferential direction (see FIGS. 18((A) and (B))). The pressure stopper surface 63a is formed into a flat shape. Then, the pressure stopper surface 63a acts to press a large number of pellets p, p toward the melting device 2 and transfer them into melting holes 22, 22.

The rear side end part 63c of the movable cylinder 63 has a through hole, in which an inner screw part is formed. The inner screw part fits with the outer screw shaft 36 of the drive unit 3 and by rotation of the outer screw shaft 36, the pressure stopper surface 63a and the movable cylinder 63 move in a reciprocating manner in the axial direction (longitudinal direction) inside the cylinder main body 11. The material of the movable cylinder 63 is iron or stainless steel, but is not limited to these. The material of the movable cylinder 63 may be any material as far as it meets the requirements for heat resistance and durability.

By movement of the movable cylinder 63 toward the melting device 2, the pellets p, p are pressed into the melting holes 22 via the inflow-side large openings 22a formed in the inflow-side surface part 2a of the melting device 2 (see FIGS. 18((A) and (B))). When each pellet p is moving from the inflow-side large opening 22a of the melting hole 22 toward the outflow-side small opening 22b, the pellet p becomes melted more and more, and when it comes near the outflow-side small opening 22b or in front of the outflow-side small opening 22b, it stops melting and is liquefied completely, and it goes out of the outflow-side small opening 22b. Further, it goes out of the tip end of the outlet member 5.

Particularly, when the melting device 2 is of the fixed type, the pellets p, p are being melted, while molten resin is injected from the tip end of the outlet member 5. With this process, it is advantageously possible to complete resin bonding (described later) instantaneously. With this melting device 2 of the fixed type, generation of molten resin coincides with injection of molten resin. Therefore, rotation of the outer screw shaft 36 of the drive unit 3 is controlled in accordance with the amount of bonded resin and the feed amounts of the first member 91 and second member 92 that are resin-bonded together are controlled thereby to enable mass production.

In the above description, the plural pellets p are supplied continuously from the pellet supply opening 11a, however, a predetermined amount of pellets p may be supplied, as illustrated in FIGS. 1 to 3. Specifically, there is provided a shutter mechanism 16, which is configured to have a shutter plate 16a and a drive source 16b such as solenoid for moving the shutter plate 16a up and down.

A lower end part of the shutter plate 16a is inserted into a groove part 12a formed at the bottom of the supply tube 12 to block the pellet supply opening 11a so that flow of the plural pellets p flowing into the supply tube 12 can be shut down. When using such a shutter mechanism 16, the flow rate and the flowing time of the pellets p are considered to control the time to open or close the shutter plate 16a. With this structure, it is possible to control the amount of pellets p to be supplied from the hopper 18 appropriately.

As described above, as the pellets are melted in desired melting amounts and injected, there is an advantageous effect of being able to process them in a well-ordered manner. The stopper part 6 of the configuration illustrated in FIG. 1 conforms in size to the inner diameter of the cylinder 1 and is formed of a thick hard synthetic resin material 62 fixed to the stopper surface 61a at the bottom end of the inside fixation cylinder 61 made of metal. With this structure, it is possible to improve the assembly process and formation easiness. Further, the cylinder 1 may be formed integral up to the position of the case 38 of the motor drive par 31.

Next description is made about the structure of the adapter 8. The adapter 8 is fundamentally configured to have a first adapter 81 and a second adapter 82. The first embodiment of the adapter 8 is formed of the first adapter 81 and the second adapter 82 as illustrated in FIG. 5((A) to (C)), and in the first adapter 81, an insertion opening 81a is formed for inserting the nozzle part 51 for injecting the molten resin q generated in the resin melting injection device A.

In back surfaces of the first adapter 81 and the second adapter 82, there are formed stopper surfaces 81b, 82b for closing connection holes 911 and 921 formed in the first member 91 and the second member 92 to be resin-bonded to each other, respectively, and for preventing the molten resin q from escaping. Specifically, when the upper and lower surfaces of the first member 91 and the second member 92 are flat surfaces, the stopper surfaces 81b, 82b are merely formed as flat surfaces.

In the case of the adapter 8 according to the first embodiment, the back surface (bottom surface) of the first adapter 81 and the back surface (upper surface) of the second adapter 82 are only formed as the flat stopper surfaces 81b, 82b, the connection holes 911 and 921 formed in the first member 91 and in the second member 92, respectively, are provided with enlarged holes 911a, 921a and tapered holes 911b, 921b for preventing detachment.

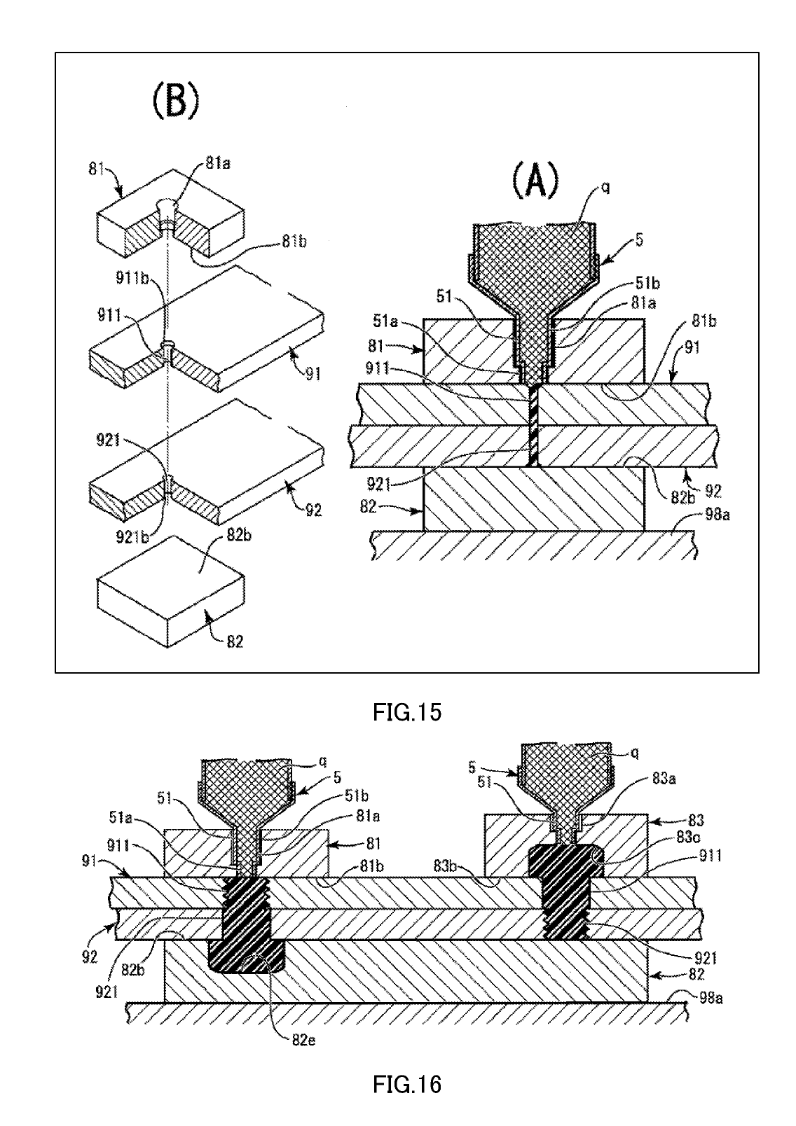

The embodiment of FIG. 5 has been described assuming that the diameter of the connection holes 911, 921 is larger than the diameter of the injection outlet 51a of the nozzle part 5. However, the diameter of the connection holes 911, 921 may be smaller than the diameter of the injection outlet 51a of the nozzle part 5, which is illustrated in FIG. 15. This is a modification to the adapter 8 according to the first embodiment. Also in this case, the first member 91 and the second member 92 have the connection holes 911, 921 formed therein, and the tapered holes 911b, 921b are also formed for preventing detachment. In the first adapter 81, the insertion opening 81a is formed for inserting the nozzle part 51 for injecting molten resin q generated in the resin melting injection device A.

As illustrated in FIG. 15, the back surfaces of the first adapter 81 and the second adapter 82 are formed as stopper surfaces 81b, 82b for closing the connection holes 911, 921 formed, respectively, in the first member 91 and the second member 92 to be resin-bonded to each other and also for preventing the molten resin q from escaping. When the diameter of the connection holes 911, 921 is smaller than the diameter of the injection outlet 51a, the first adapter 81 is not necessarily required. However, when molten resin q is injected for resin bonding, relatively high pressure is applied. Therefore, the first adapter 81 and the second adapter 82 are required to be fixed strongly not to move away from each other.

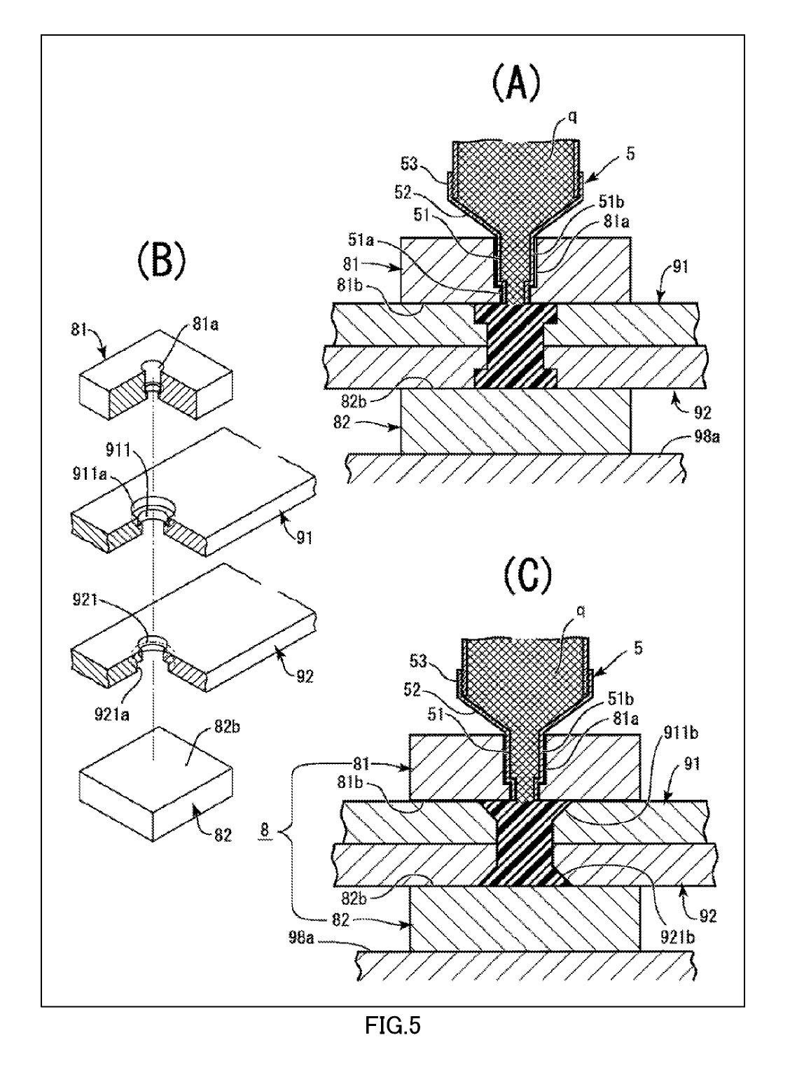

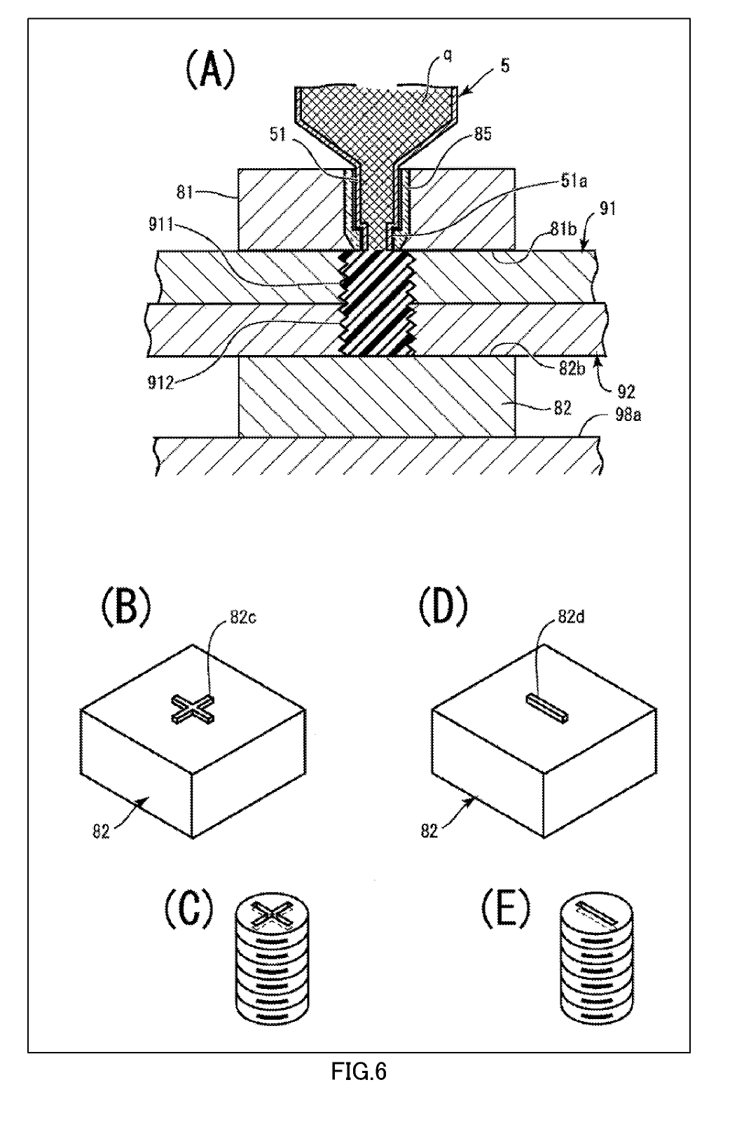

In the case of the modification to the adapter 8 according to the first embodiment, as illustrated in FIG. 6, in the back surface of the second adapter 82, a small cross-shaped projection part 82c or straight-shaped projection part 82d is formed and the part excluding the small cross-shaped projection part 82c or straight-shaped projection part 82d is formed as a flat stopper surface 82b. In this case, the connection holes 911, 921 formed, respectively, in the first member 91 and in the second member 92 for resin bonding are formed as screw holes.

When the first member 91 and the second member 92 are thus resin-bonded, and then, if the first member 91 and the second member 92 are to be separated temporarily, the resin hardened in resin bonding may be used as a headless screw. If the first member 91 and the second member 92 are finally to be disassembled, as the molten resin q is used, the resin is heated above the melting temperature of the resin so that the bonding is destroyed thereby to make the first member 91 and the second member 92 disassembled easily.

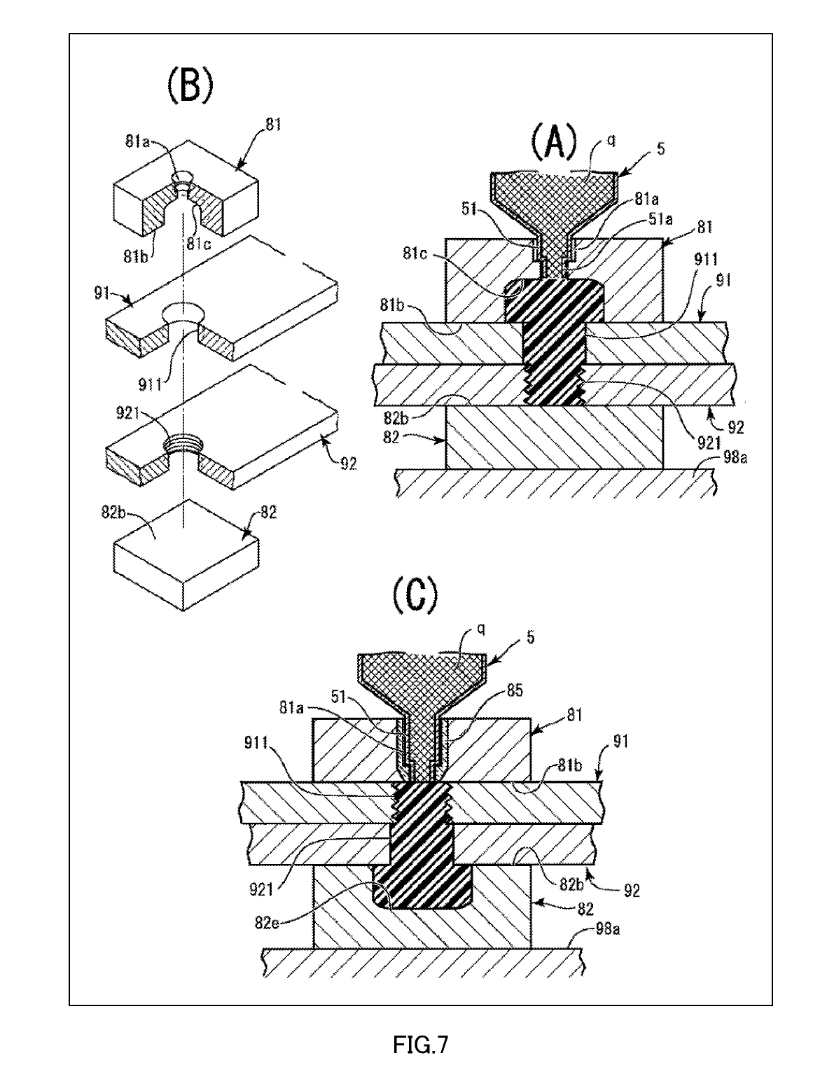

The adapter 8 according to the second embodiment is comprised of the first adapter 81 and the second adapter 82, as illustrated in FIG. 7(A). In the first adapter 81, the insertion opening 81a is formed for inserting the nozzle part 51 for injecting the molten resin q generated in the resin melting injection device A. In the back surface of the first adapter 81, there is formed a recess part 81c for closing the connection hole 911 formed in the first member 91 and for forming a bulged part that corresponds to a bolt head of larger diameter than the diameter of the connecting holes 911, 921. The flat part other than the recess part 81c is formed as the stopper surface 81b for preventing the molten resin q from escaping.

In the second adapter 82, a flat surface for closing the connection hole 921 as the screw hole formed in the second member 92, and it is formed as the stopper surface 82b as the surface for preventing the molten resin q from escaping. In this case, the first member 91 and the second member 92 are bonded to each other by a resin bolt. If disassembling is requested, it is advantageously possible to disassemble the first member 91 and the second member 92 by loosening the resin bolt, which is hardened in resin bonding, and also possible to return them into an original state.

In a modification to the adapter 8 according to the second embodiment, as illustrated in FIG. 7(C), the adapter 8 is comprised of the first adapter 81 and the second adapter 82. In the first adapter 81, the insertion opening 81a is formed for inserting the nozzle part 51 for injecting molten resin q generated in the resin melting injection device A. The back surface of the first adapter 81 is formed as the stopper surface 81b for closing the connection hole 911 formed in the first member 91 and also for preventing the molten resin q from escaping. In the insertion opening 81a of FIG. 7(C), an insulating material 85 made of hard synthetic resin may be provided between the nozzle part 51 and the insertion opening 81a so as to prevent the molten resin q from being cooled and to prevent clogging in the nozzle part 51.

In the second adapter 82, there is formed a recess part 82e for closing the connecting hole 921 formed in the second member 92 and for forming a bulged part 82e that corresponds to a bolt head of larger diameter than the diameter of the connecting hole 921. The flat surface excluding the recess part 82e is formed as the stopper surface 82b for preventing the molten resin q from escaping. Also in this case, the first member 91 and the second member 92 are bonded to each other by a resin bolt. If disassembling is requested, it is advantageously possible to disassemble the first member 91 and the second member 92 by loosening the resin bolt, which is hardened in resin bonding, and also possible to return them into an original state.

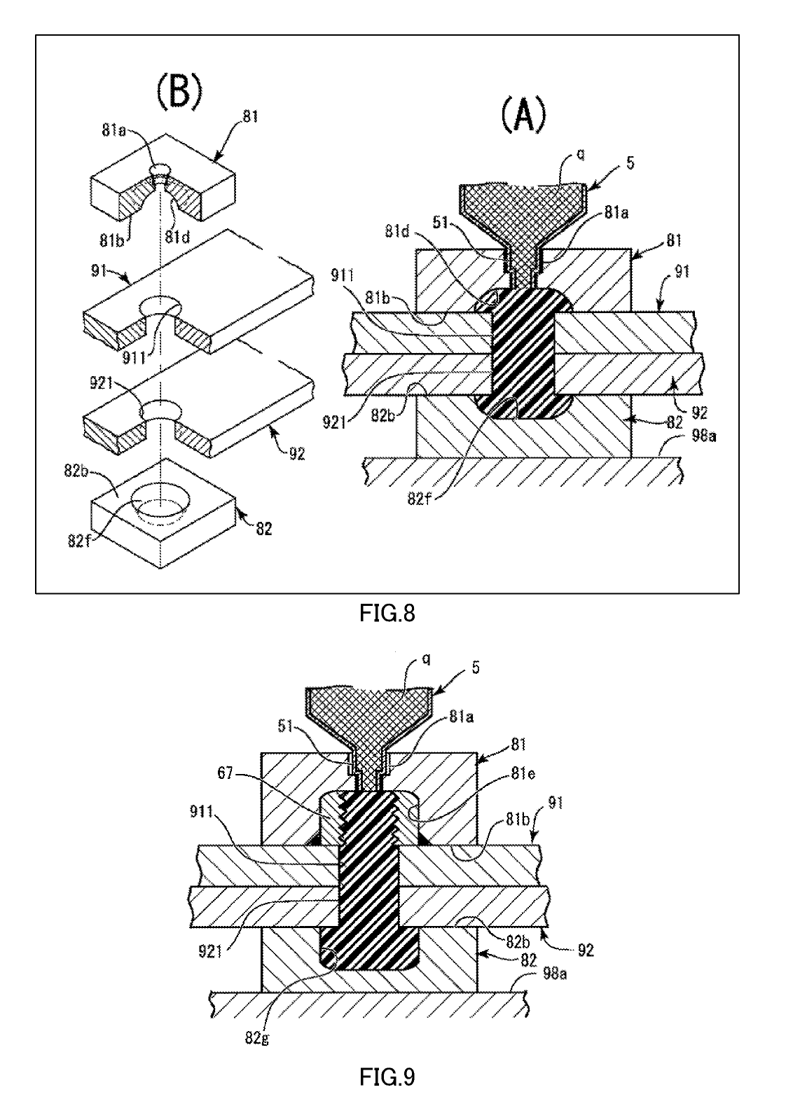

The adapter 8 according to the third embodiment is comprised of the first adapter 81 and the second adapter 82, as illustrated in FIG. 8. In the first adapter 81, the insertion opening 81a is formed for inserting the nozzle part 51 for injecting the molten resin q generated in the resin melting injection device A. In the back surfaces of the first adapter 81 and the second adapter 82, there are formed recess parts 81d, 82f for closing the connection holes 911, 921 formed, respectively, in the first member 91 and the second member 92 and for forming bulged parts of larger diameter than the diameter of the connecting holes 911, 921. The flat parts other than the recess parts 81d, 82f are formed as the stopper surfaces 81b, 82b for preventing the molten resin q from escaping.

Specifically, in the embodiment, the connecting holes 911, 921 formed, respectively, in the first member 91 and the second member 92 for resin bonding are closed, while bulged resin parts Q1 are formed at the upper and lower ends of the overlapping connecting holes 911, 921. The molten resin q functions as a rivet as a whole thereby to allow bonding (adhesion). According to the present invention, as far as the first member 91 and the second member 92 are prepared, it is possible to resin-bond the first member 91 and the second member 92 instantaneously and with high airtightness and high water-tightness.

In addition, in a modification to the third embodiment, as illustrated in FIG. 9, the adapter 8 is comprised of the first adapter 81 and the second adapter 82. The first adapter 81 is of such a type that a metal nut 67 is adhered in advance by welding or the like according to need. In this case, in the first adapter 81, a recess part 81e is formed for receiving the metal nut 67 and in the second adapter 82, a recess part 82g is formed for receiving the bolt head of the resin bolt.

The bolt head of the resin bolt may be hexagonal head, square head or bolt head that fits to the hexagonal wrench. Or, the metal nut 67 also may be of any shape such as square or octagonal. Also in this embodiment, if disassembling of the first member 91 and the second member 92 is desired, it is advantageously possible to disassembly the first member 91 and the second member 92 by loosening the resin bolt, which is hardened in resin bonding. As the metal nut 67 is used, it is possible to allow strong bonding and also possible to return them into an original state. If the metal nut 67 is not welded, there is a merit of facilitating disassembling as a whole.

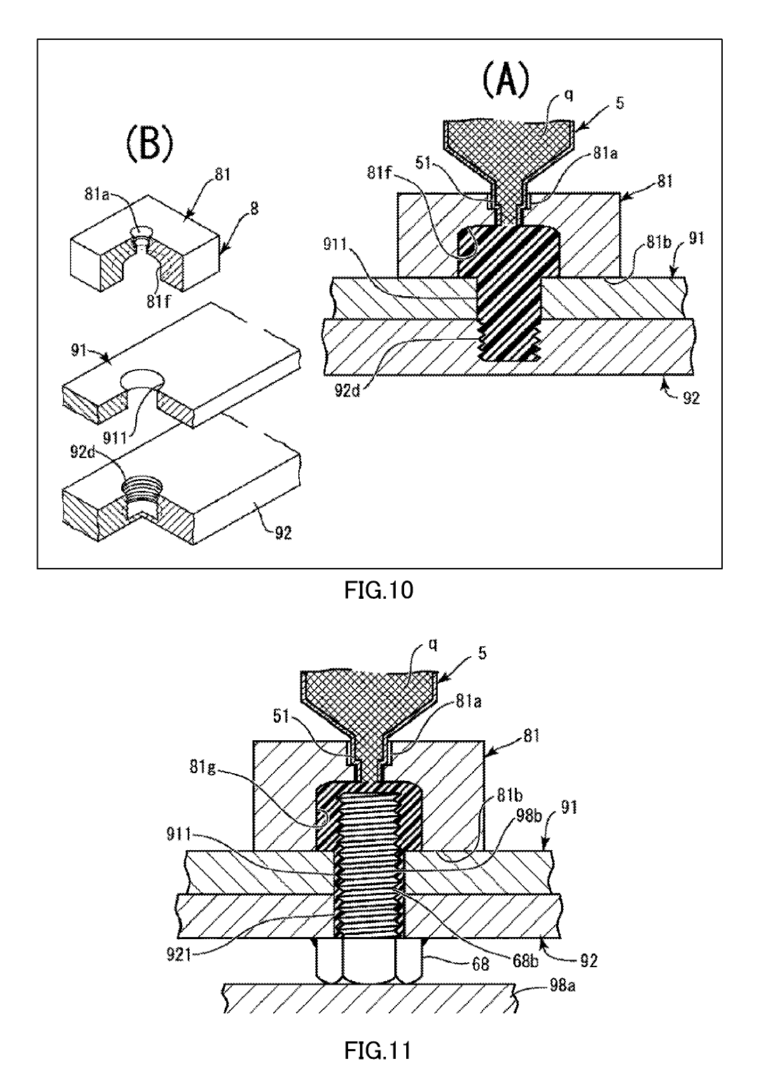

According to the fourth embodiment, the adapter 8 is comprised only of the first adapter 81, as illustrated in FIG. 10. In the first adapter 81, the insertion opening 81a is formed for insertion of the nozzle part 51 for injecting the molten resin generated in the resin melting injection device A. In the back surface of the first adapter 81, there is formed a recess part 81f for closing the connection hole 911 formed in the first member 91 and for forming a bulged part as a bolt head of a resin bolt of larger diameter than the diameter of the connecting hole. The stopper surface 81b is also formed as a surface for preventing the molten resin q from escaping.

At that time, in the second member 92, there is formed a hole part 92d as a screw hole. When high strength is required, the hole part needs to be formed relatively deeper. With this structure, it is possible to eliminate the need to provide the second adapter 82. The connecting hole 911 of the first member 91 is formed as a simple hole. In the embodiment of this type, only one adapter is used thereby to achieve cost saving.

In a modification to the fourth embodiment, as illustrated in FIG. 11, the adapter 8 is comprised only of the first adapter 81. The second member 92 is of such a type that a metal bolt 68 is adhered in advance by welding or the like according to need. As the bolt head of the metal bolt 68 is supported, it is possible to prevent leakage of the resin and also possible to omit the second adapter 68. In the first adapter 81 of this type, there is formed a recess part 81g as a resin hexagon cap nut for accommodating the bolt shaft 68b of the metal bolt 68 in a covering manner, and there is also formed the stopper surface 81b for preventing the molten resin q from escaping.

The resin hexagon cap nut may be any shape, such as hexagon, square or shape that fits to the hexagonal wrench. Or, the metal bolt 68 also may be of any shape such as square or octagonal. Also in this embodiment, if disassembling of the first member 91 and the second member 92 is desired, it is advantageously possible to disassembly the first member 91 and the second member 92 by loosening the resin hexagon cap nut, which is hardened in resin bonding. Particularly, as the metal bolt 68 is used, it is possible to allow strong bonding and also possible to return them into an original state. If the metal bolt 68 is not welded, there is a merit of facilitating disassembling as a whole.

In the case of FIG. 11, the connecting holes 911, 921 are formed in the first member 91 and in the second member 92, respectively. However, after the resin hexagon cap nut is resin-bonded, molten resin q is clogged in a gap between the bolt shaft of the metal bolt 68 and the connecting holes 911, 921 thereby to achieve high airtightness and high water-tightness.

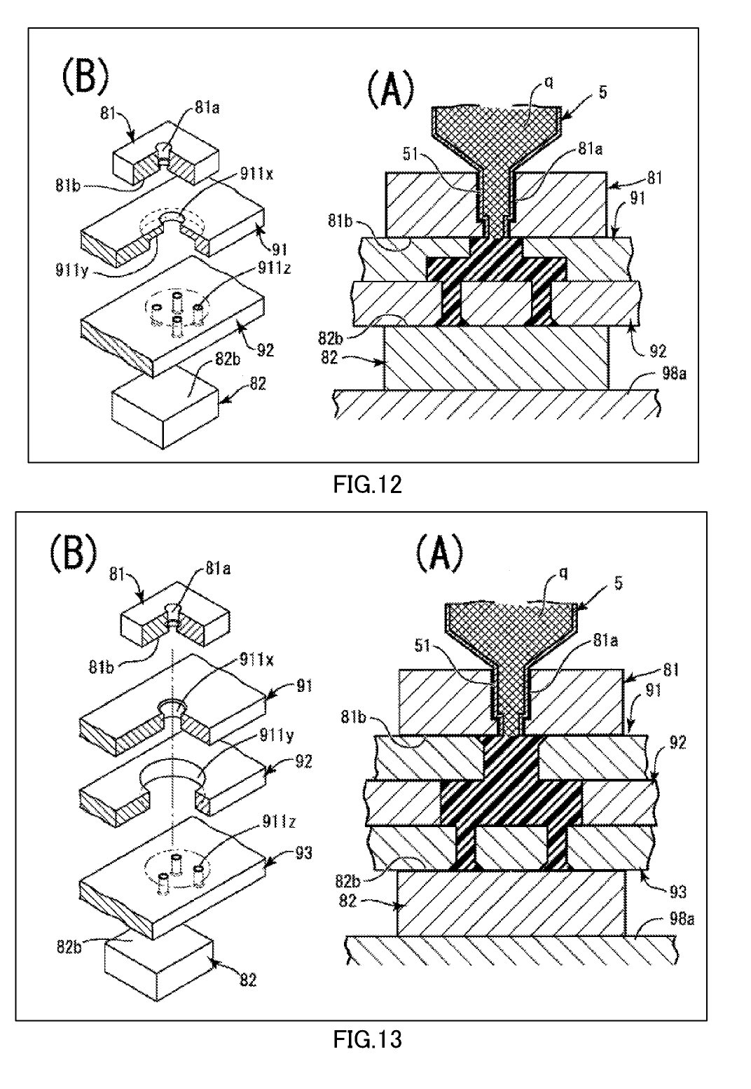

FIG. 12 illustrates the adapter 8 according to the first embodiment, however, in this adapter 8, the shape of the holes of the first member 91 and the second member 92 for resin bonding is made special. In the first member 91, a middle hole 911x and a large-diameter hole 911y are formed with a step and in the second member 92, a plurality of (four) small holes 911z are formed in the second member 92. Each of the small holes is tapered at an end. Even with these complicated holes, according to the present invention, it is advantageously possible to perform resin bonding instantaneously.

FIG. 13 illustrates the adapter 8 according to the first embodiment, however, in this adapter 8, a third member is added to the first member 91 and the second member 92 for resin bonding, and the holes are also formed into special shapes. In the first member 91, a tapered middle hole 911x is formed, and in the second member 92, a large-diameter hole 911y is formed. In the third member 93, a plurality of (four) small holes 911x are formed and each of the small holes is tapered at an end. Even with these complicated holes, according to the present invention, it is advantageously possible to perform resin bonding instantaneously.

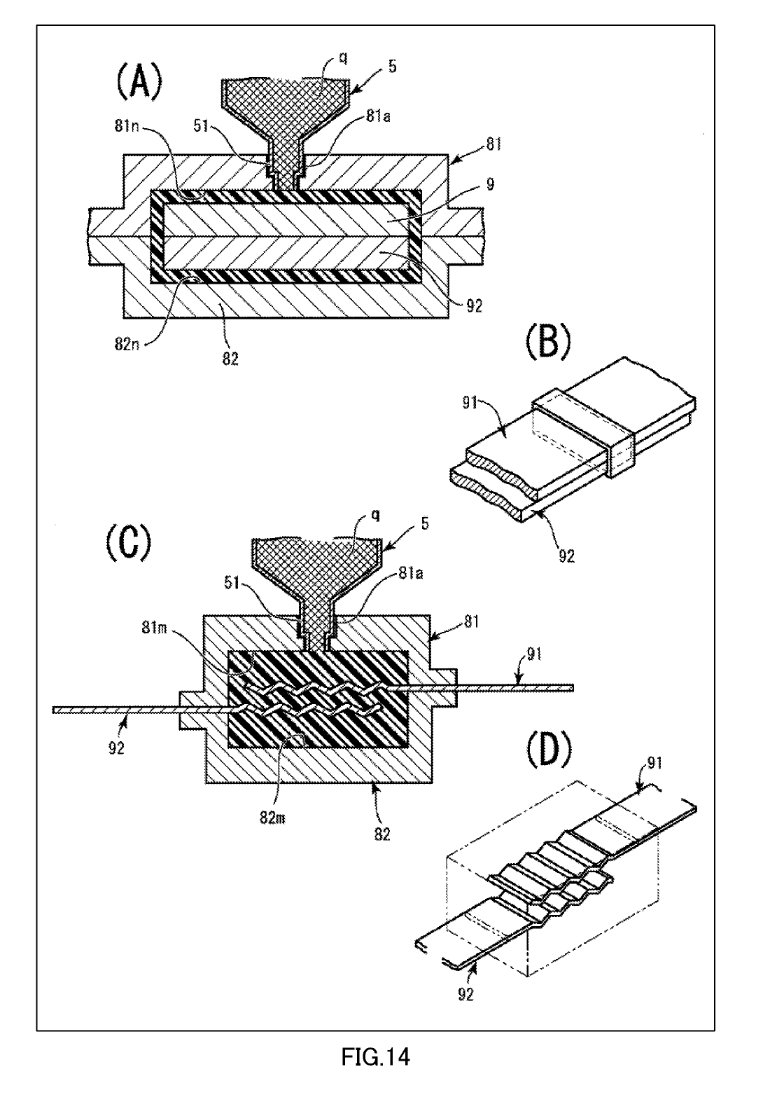

The adapter 8 according to the fifth embodiment is comprised of the first adapter 81 and the second adapter 82, as illustrated in FIG. 14(A). In the first adapter 81, the insertion opening 81a is formed for inserting the nozzle part 51 for injecting the molten resin q generated in the resin melting injection device A. In the first adapter 81, there is also formed a groove 81n that extends to surround the first member and the second member around. Further, the groove 81n is connected to the insertion opening 81a and has a surface that overlaps the back surface of the second adapter 82. The second adapter 82 is formed in the same shape as the first adapter 81.

Particularly, in the inner surface of the second adapter 82, there is also formed a groove 82n that extends to surround the first member 91 and the second member 92 around. The groove 82n is configured to communicate with the groove 81n of the first adapter 81. With this structure, it is possible to bond the first member 91 and the second member 92 to each other even if there is no hole and no notch. Besides, if disassembling is desired, it is possible to disassembly the first member 91 and the second member 92 by heating them above the melting temperature of the resin-bonded molten resin q and melting the resin. That is, it is possible to return the first member 91 and the second member 92 in to an original state.

In a modification to the fifth embodiment, as illustrated in FIG. 14(C), the adapter 8 is comprised of the first adapter 81 and the second adapter 82. In the first adapter 81, the insertion opening 81a is formed for inserting the nozzle part 51 for injecting the molten resin q generated in the resin melting injection device A. There is also formed a large recess part 81m that extends to surround the first member and the second member around.

Further, as illustrated in FIG. 14(C), the large recess part 81m is formed to communicate with the insertion hole 81a and has a surface that overlaps the back surface of the second adapter 82. The second adapter 82 is formed in the same shape as the first adapter 81. In the second adapter 82, there is also formed a large recess part 82m that extends to surround the first member and the second member around. The overlapping surfaces of the first adapter 81 and the second adapter 82 are each formed to have a step. Besides, as illustrated in FIG. 14(D), after resin bonding is completed, the first member 91 and the second member 92 are separated from each other.

In the sixth embodiment, as illustrated in FIG. 16, the adapter 8 is configured to be implemented as two resin melting injection devices A and three adapters 8. Specifically, in a first adapter 81, the insertion opening 81a is formed for inserting the nozzle part 51 for injecting the molten resin q generated in the resin melting injection device A. The back surface of the first adapter 81 is formed as the stopper surface 81b for closing the connection hole 911 formed in the first member 91 and also for preventing the molten resin q from escaping.

In a second adapter 82, a recess part 82e is formed for closing the connection holes 921 formed in the second member 92 and also for forming a bulged part corresponding to a bolt head of larger diameter than the diameter of the connection hole 921. The flat surface excluding the recess part 82e is formed as the stopper surface 82b for preventing the molten resin q from escaping. Also in this case, the first member 91 and the second member 92 are bonded to each other by a resin bolt. Particularly, the second adapter 82 is formed to have a large width.

A third adapter 83 is provided on the first member 91 slightly apart from the first adapter 81. That is, as illustrated in the right side of FIG. 16, in the third adapter 83, an insertion opening 83a is formed for inserting the nozzle part 51 for injecting the molten resin q generated in the resin melting injection device A. In the back surface of the third adapter 83, there is also formed a recess part 83c for closing the connection hole 911 formed in the first member 91 and for forming a bulged part corresponding to a bolt head of larger diameter than the diameter of the connection holes 911 and 921.

The flat surface excluding the recess part 83c is formed as a stopper surface 83b for preventing the molten resin q from escaping. In the third adapter 83, the flat surface is formed only for closing the connection hole 921 as a screw hole formed in the second member 92, which surface is also formed as the stopper surface 82b for preventing the molten resin q from escaping. In this case, the first member 91 and the second member 92 are bonded to each other by resin bolts.

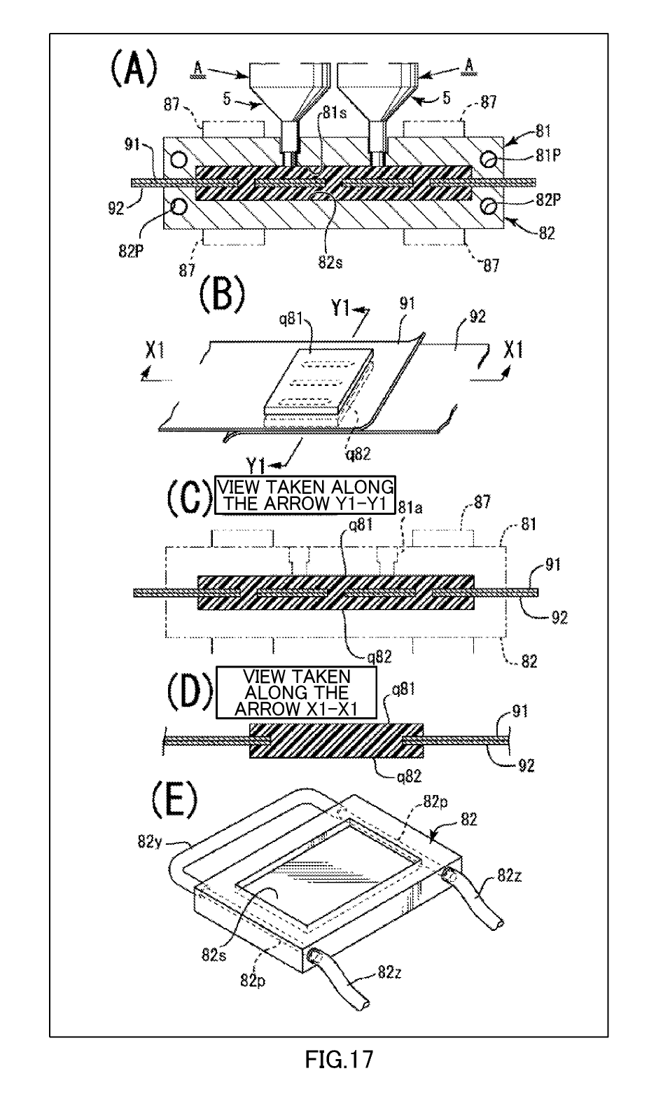

In the seventh embodiment, as illustrated in FIG. 17, the adapter 8 is configured to use a plurality of nozzles in order to broaden the flowing area of resin in the case of bonding of large-area materials such as thin plates, sheets or the like. That is, this embodiment is configured with two resin melting injection devices A and two adapters 8. Specifically, in overlapping surfaces of the first adapter 81 and the second adapter 82, large recess parts 81s and 82s are formed, respectively, for forming plate-shaped resin connectors q81 and q82.

In the first member 91 and second member 92 like thin plates, sheets or the like, connection holes 912, 921 are formed as long holes at three parts between the two plates. That is, three holes are formed within the widths of the recess parts 81s, 82s. In addition, in the first adapter 81, two insertion openings 81a are formed each for inserting the nozzle part 51 for injecting the molten resin q generated in the resin melting injection device A. The product is manufactured as illustrated in FIG. 17(B), but the cross sections of the resin connectors q81, q82 and connection holes 912, 921 are illustrated in FIGS. 17((C) and (D)).

Particularly, when the resin connectors q81, q82 are wide and large sized, temperature control is required. Therefore, as illustrated in FIG. 17(E), water passage holes 82p are formed at two lines and these are connected by connection pipes 82x, 82y, 82z, thereby forming a cooling structure. In addition, in the first adapter 81, there are also provided two-line water passage holes 81p, 81p, which are also connected by connection pipes 81x, 81y and 81z. Further, at the back surface sides of the first adapter 81 and the second adapter 82, a plurality of Peltier devices 87 may be provided for cooling.

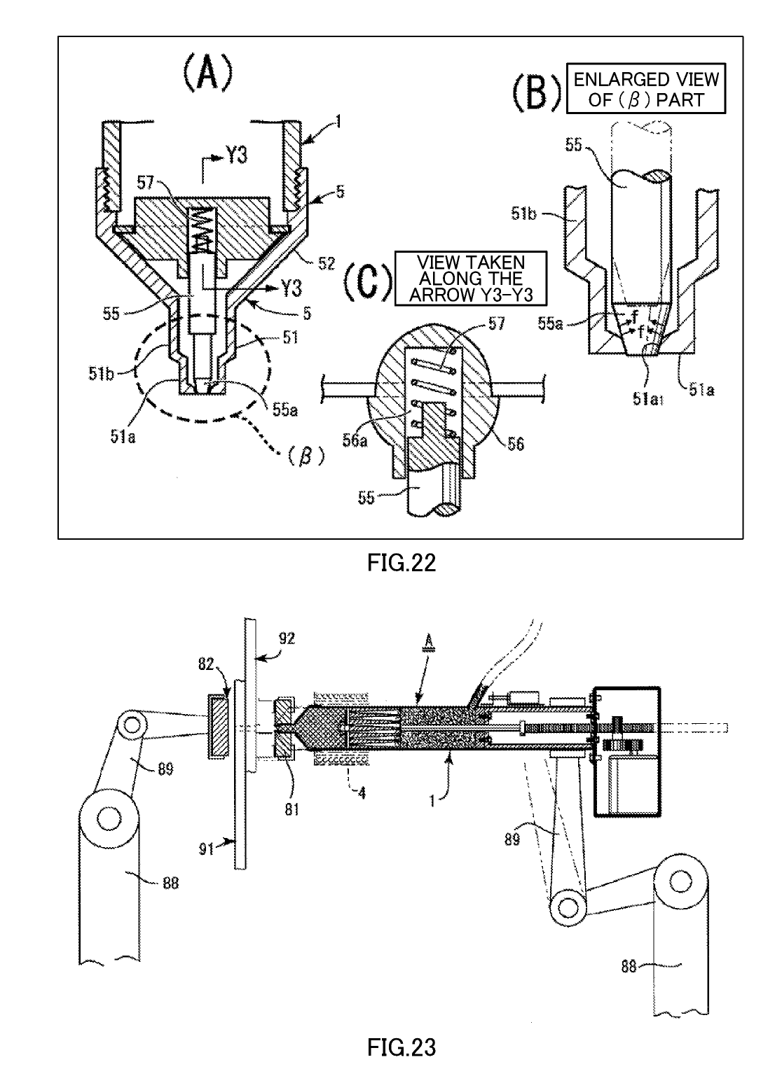

As illustrated in FIG. 22, in the outlet member 5 part, there is provided a gate pin opening mechanism according to need. The gate pin opening mechanism is configured to have a bar-shaped outlet mount part 56 that is horizontally installed in the connection part 51a in the outlet member 5 part and a gate pin 55. The lower end (tip end) of the gate pin 55 is formed as a tapered part 55a and the upper part (rear part) is accommodated to be movable up and down in an accommodating part 56a of the outlet mount part 56.

Further, between the upper end (rear end) of the gate pin 55 and the upper end of the accommodating part 56a, a compression spring is provided to always urge the gate pin 55 downward elastically. The inner diameter of an injection tip end opening 51a1 of the injection opening 51a of the nozzle part 51 is formed to fit in the same plane with the tapered part 55a of the gate pin 55 with no gap provided therebetween. And, a most part of the tapered part 55a is configured to be located within the injection opening 51a.

Next description is made about the operation state of the gate pin opening mechanism. In such a structure, when the outlet member 5 part is fully charged with molten resin q under pressure, the pressed molten resin q is moved all around the tapered part 55a of the gate pin 55. Then, as illustrated in FIG. 22(B), a force f applied to the tapered part 55a becomes an upward tilt force and its vertical force only lifts the gate pin 55 up. At this moment, the injection tip end opening 51a1 of the injection opening 51a is opened and the molten resin q is injected.

When injection is finished, the pressure on the molten resin q becomes lost and the gate pin 55 is elastically urged downward by the compression spring 57 thereby to close the injection tip end opening 51a1. As this gate pin opening mechanism is provided, the resin hardened by resin bonding and molten resin q within the outlet member 5 part are separated excellently thereby to accomplish resin bonding in an orderly manner.

In the embodiment as illustrated in FIG. 23, the first adapter 81 and the resin melting injection device A as main parts of the present invention are mounted on a tip end of an arm 89 of a robot 88, and the second adapter 82 is mounted on a tip end of an arm 89 of another robot 88 thereby to enable resin bonding of the first member 91 and second member 92 of appropriate shape and material. This embodiment shows the image of 24-hour support in a robot factory. Particularly, in FIG. 23, the resin melting injection device A is illustrated as a larger sized device as compared with the first joint part pf the arm 89 of the robot 89. This is only for easy understanding of each element of the resin melting injection device A, and FIG. 23 is merely an image view.

The first adapter 81, the second adapter 82 and the third adapter 83 thus described up to this point are all flat plate-shaped adapters, which shape fits the first member 91 and the second member 92. However, the adapter shape is not limited to a flat plate and may be any of various shapes that can fit the right angle, corner, curved plate, square bar, round bar, sheet and so on.

Further, the material of the first adapter 81 and the second adapter 82 may be metal, glass, resin, timber or the like, but it is often metal. The material of the first adapter 81 and the material of the second adapter 82 are often the same, but may be different depending on the use application or the material of the first member 91 and the second member 92, and for example, they may be aluminum and iron, iron and plastic, or the like.

Regarding the device for installing the resin melting injection device A, as explained with reference to FIGS. 1 and 23, in the case where the injection pressure is large, there is need to increase the support and fixation force of the first adapter 81 and the second adapter 82. Therefore, the present invention is not limited to the above-described embodiments, but may be configured that a strong clamp is provided, or that the second adapter 82 and the like are installed on a fixed base and the resin melting injection device A and the first adapter 81 are provided movable.

### INDUSTRIAL APPLICABILITY

The present invention enables an extremely wide variety of resin bonding of two or more members and exhibits extremely high industrial applicability in various manufacturing industry.

### REFERENCE NUMERALS

1 . . . cylinder
11a . . . pellet supply opening
2 . . . melting device
21a . . . inflow-side surface part
21b . . . outflow-side surface part
22 . . . melting hole
22a . . . inflow-side large opening
22b . . . outflow-side small opening
3 . . . drive unit
4 . . . heating unit
5 . . . outlet member
51 . . . nozzle part
6 . . . stopper part
91 . . . first member
92 . . . second member
8 . . . adapter
81 . . . first adapter
81a insertion opening
81b, 82b . . . stopper surface
82 . . . second adapter
81c, 81d, 81e, 81f, 82f, 82g . . . recess part
81m, 82m, 81n, 82n, 81s, 82s . . . large recess part
p . . . pellet
q . . . molten resin

1. A resin bonding device comprising:
a resin melting injection device having:
a cylinder having an outlet member formed at a tip-end injection side in a longitudinal direction, a stopper part provided at a rear side, and a pellet supply opening provided in an intermediate position between the stopper part and the outlet member for supplying plastic pellets;
a melting device having a plurality of melting holes formed communicating from inflow-side large openings to outflow-side small openings in the longitudinal direction of a device main body, the melting device having a diameter equal to an inner diameter of the cylinder;
a heating unit for heating the melting device; and
a drive unit for causing the melting device to move in a reciprocating manner,
wherein the outflow-side small openings of the melting device face the outlet member, the melting device operates as a plunger in the cylinder, and a return travel by the drive unit is configured to correspond to a melting step of melting the plastic pellets and an outward travel by the drive unit is configured to correspond to an injection step of molten resin,
in the cylinder, an opening and closing valve is provided between the outlet member and the melting device, and
the opening and closing valve is configured to open the outflow-side small openings of the melting device in the melting step and to close the outflow-side small openings of the melting device in the injection step; and
an adapter for applying the molten resin injected from the outlet member, to at least one side surface of a first member and a second member and preventing the molten resin from escaping to resin-bond the first member and the second member to each other.

2. The resin bonding device according to claim 1, wherein the adapter comprises a first adapter and a second adapter, the first adapter has an insertion opening formed therein for inserting a nozzle part for injecting the molten resin generated in the resin melting injection device, and back surfaces of the first adapter and the second adapter are formed to have stopper surfaces for closing connection holes formed respectively in the first member and the second member and for preventing the molten resin from escaping.

3. The resin bonding device according to claim 1, wherein the adapter comprises a first adapter and a second adapter, the first adapter has an insertion opening formed therein for inserting a nozzle part for injecting the molten resin generated in the resin melting injection device, and a back surface of the first adapter or the second adapter is formed to have a recess part for closing connection holes formed in the first member and the second member and for forming a bulged part of larger diameter than a diameter of the connection holes.

4. The resin bonding device according to claim 1, wherein the adapter comprises a first adapter and a second adapter, the first adapter has an insertion opening formed therein for inserting a nozzle part for injecting the molten resin generated in the resin melting injection device, and back surfaces of the first adapter and the second adapter are formed to have recess parts for closing connection holes formed respectively in the first member and the second member and for forming bulged parts of larger diameter than a diameter of the connection holes.

5. The resin bonding device according to claim 1, wherein the adapter is formed as a first adapter, the first adapter has an insertion opening formed therein for inserting a nozzle part for injecting the molten resin generated in the resin melting injection device and is formed to prevent the molten resin from escaping, a back surface of the first adapter is formed to have a recess part for closing a connection hole formed in the first member and for forming a bulged part of larger diameter than a diameter of the connection hole and the first member and the second member are bonded to each other by the molten resin.

6. The resin bonding device according to claim 1, wherein the adapter comprises a first adapter and a second adapter, the first adapter has an insertion opening for injection of the molten resin, inner surfaces of the first adapter and the second adapter are formed to have a groove that surrounds the first member and the second member around and the groove is formed to communicate with the insertion opening.

7. The resin bonding device according to claim 1, wherein a gate pin is provided inside the outlet member, and when the molten resin is being injected, the gate pin and a nozzle part are opened, and when injection is finished, the gate pin and the nozzle part are closed.

8. The resin bonding device according to claim 7, wherein the gate pin is always controlled to close the nozzle part by an elastic force, a tip end of the gate pin is formed as a tapered part and a tip end inner shape of the nozzle part is formed as an injection tip end opening corresponding to the tapered part.

9. The resin bonding device according to claim 1, wherein the adapter comprises a first adapter and a second adapter, the resin melting injection device comprises a plurality of resin melting injection devices, the first adapter or the second adapter has an insertion opening formed therein for inserting a nozzle part for injecting the molten resin generated in the resin melting injection device and a back surface of the first adapter or the second adapter is formed to have a resin connector for closing connection holes formed in the first member and the second member and to have a stopper surface for preventing the molten resin from escaping.

10. A resin bonding device comprising:
a resin melting injection device having:
a cylinder having an outlet member formed at a tip-end injection side in a longitudinal direction, a cylindrical plunger with a stopper part provided at a rear side, and a pellet supply opening provided in an intermediate position between the plunger and the outlet member for supplying plastic pellets;
a drive unit for causing the plunder to move in an axial direction in a reciprocating manner,
a melting device having a plurality of melting holes formed communicating from inflow-side large openings to outflow-side small openings in the longitudinal direction of a device main body;
a nozzle that is provided at an injection side of the cylinder; and
a heating unit for heating the melting device,
wherein the melting device is arranged between the plunger and the outlet member, and the plastic pellets supplied from the pellet supply opening flow into the inflow-side large openings by pressure of the plunger and flow out from the outflow-side small openings as molten resin; and
an adapter for applying the molten resin injected from the outlet member, to at least one side surface of a first member and a second member and preventing the molten resin from escaping to resin-bond the first member and the second member to each other.
